(19) United States
(12) Patent Application Publication
(10) Pub. No.: US 2025/0361111 A1
(43) Pub. Date: Nov. 27, 2025

(54) MEDIUM PROCESSING APPARATUS, IMAGE FORMING APPARATUS, AND IMAGE FORMING SYSTEM

(71) Applicants: Suzuka FUJITA, Kanagawa (JP); Yuusuke SHIBASAKI, Kanagawa (JP); Yusuke HIRONO, Kanagawa (JP); Atsushi SHINODA, Kanagawa (JP); Shuuto TOHKAISHI, Kanagawa (JP); Sho ASANO, Kanagawa (JP); Wataru TAKAHASHI, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Naofumi YOSHIDA, Kanagawa (JP); Ryota TAKAYAMA, Kanagawa (JP); Hirotaka YASUKAWA, Kanagawa (JP); Yoshito SUZUKI, Kanagawa (JP); Shinya MONMA, Kanagawa (JP); Takahiro WATANABE, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP); Naohiro YOSHIDA, Kanagawa (JP)

(72) Inventors: Suzuka FUJITA, Kanagawa (JP); Yuusuke SHIBASAKI, Kanagawa (JP); Yusuke HIRONO, Kanagawa (JP); Atsushi SHINODA, Kanagawa (JP); Shuuto TOHKAISHI, Kanagawa (JP); Sho ASANO, Kanagawa (JP); Wataru TAKAHASHI, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Naofumi YOSHIDA, Kanagawa (JP); Ryota TAKAYAMA, Kanagawa (JP); Hirotaka YASUKAWA, Kanagawa (JP); Yoshito SUZUKI, Kanagawa (JP); Shinya MONMA, Kanagawa (JP); Takahiro WATANABE, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP); Naohiro YOSHIDA, Kanagawa (JP)

(73) Assignee: Ricoh Company, Ltd., Tokyo (JP)

(21) Appl. No.: 19/191,084

(22) Filed: Apr. 28, 2025

(30) Foreign Application Priority Data
May 22, 2024 (JP) 2024-083640
Feb. 12, 2025 (JP) 2025-020980

(51) Int. Cl. B65H 37/04; B41J 3/44; B65H 43/00; G03G 15/00

(52) U.S. Cl. CPC B65H 37/04; B41J 3/44; B65H 43/00; G03G 15/6544; B65H 2301/5161; B65H 2551/21; B65H 2551/24; B65H 2801/27

(57) ABSTRACT

A medium processing apparatus includes a housing, a binder, first and second sensors, and circuitry. The housing has a space in a part. The binder is disposed in the space to perform a binding operation on a sheet bundle. The first sensor is in the space to detect a first side of the sheet bundle in a first direction, and output a first detection signal. The second sensor is adjacent to the first sensor in the space to detect a second side of the sheet bundle adjacent to the first side in a second direction, and output a second detection signal. The circuitry is to input the first and second detection signals, output a notification that the binding operation is executable by the binder, and cause the binder to perform the binding operation in response to receiving an instruction to start the binding operation.

### CROSS-REFERENCE TO RELATED APPLICATIONS

This patent application is based on and claims priority pursuant to 35 U.S.C. § 119 (a) to Japanese Patent Application Nos. 2024-083640, filed on May 22, 2024, and 2025-020980, filed on Feb. 12, 2025, in the Japan Patent Office, the entire disclosure of each of which is hereby incorporated by reference herein.

### BACKGROUND

### Technical Field

Embodiments of the present disclosure relate to a medium processing apparatus, an image forming apparatus, and an image forming system.

### Related Art

A medium processing apparatus is known in the art that performs a given operation on a sheet medium as a process target object.

As a given operation that can be performed in a medium processing apparatus, in other words, a post-processing process of an image forming operation that is referred to as a “post-processing operation”, for example, a “sheet binding operation” to bind multiple sheets as media to form a sheet bundle.

A medium processing apparatus in the art is known that includes a device to perform a sheet binding operation (manual stapling) to bind a sheet bundle by inserting the sheet bundle into a gap (slit) to which the sheet bundle can be inserted by a user.

The medium processing apparatus in the art includes a sensor to detect that a sheet bundle is inserted in the slit. However, the condition of the sheet bundle in the slit cannot be determined and it is likely that the sheet binding operation with respect to the sheet bundle is performed on a portion other than a predetermined portion.

### SUMMARY

Embodiments of the present disclosure described herein provide a novel medium processing apparatus including a housing, a binder, a first sensor, a second sensor, and circuitry. The housing has a space in a part of the housing. The binder is disposed in the space to perform a binding operation on a sheet bundle bundling multiple media including a medium. The first sensor is disposed in the space to detect a first side of the sheet bundle in a first direction, the first side forming an outer edge of the sheet bundle, and output a first detection signal. The second sensor is disposed adjacent to the first sensor in the space to detect a second side of the sheet bundle adjacent to the first side, the second side forming another outer edge of the sheet bundle in a second direction different from the first direction, and output a second detection signal. The circuitry is to input the first detection signal output by the first sensor and the second detection signal output by the second sensor, output a notification that the binding operation is executable by the binder, and cause the binder to perform the binding operation in response to receiving an instruction to start the binding operation.

Further, embodiments of the present disclosure described herein provide an image forming apparatus including an image forming device to form an image on a medium, and the above-described medium processing apparatus to perform a binding operation on the medium on which the image is formed by the image forming device.

Further, embodiments of the present disclosure described herein provide an image forming system including an image forming apparatus, a medium processing apparatus, and circuitry. The image forming apparatus forms an image on a medium. The medium processing apparatus is coupled to the image forming apparatus to form a sheet bundle bundling multiple media including the medium. The medium processing apparatus includes a housing, a binder, a first sensor, and a second sensor. The housing has a space in a part of the housing. The binder is disposed in the space to perform a binding operation on a sheet bundle bundling multiple media including a medium. The first sensor is disposed in the space to detect a first side of the sheet bundle in a first direction, the first side forming an outer edge of the sheet bundle, and output a first detection signal. The second sensor is disposed adjacent to the first sensor in the space to detect a second side of the sheet bundle adjacent to the first side, the second side forming another outer edge of the sheet bundle in a second direction different from the first direction, and output a second detection signal. The circuitry is to input the first detection signal output by the first sensor and the second detection signal output by the second sensor, output a notification that the binding operation is executable by the binder, and cause the binder to perform the binding operation in response to receiving an instruction to start the binding operation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external view of an image forming system according to an embodiment of the present disclosure;

FIG. 2 is an external view of an image forming system according to another embodiment of the present disclosure;

FIG. 3A is a diagram illustrating an example of a functional block of an image forming system according to an embodiment of the present disclosure;

FIG. 3B is a diagram illustrating an example of a structure of the image forming system of FIG. 3A;

FIG. 4A is a diagram illustrating another example of a functional block of an image forming system according to an embodiment of the present disclosure;

FIG. 4B is a diagram illustrating another example of a structure of the image forming system of FIG. 4A;

FIG. 5 is a diagram illustrating a functional block of a sheet binding unit according to an embodiment of the present disclosure;

FIGS. 6A and 6B are diagrams illustrating a basic configuration of a sheet binding unit according to an embodiment of the present disclosure;

FIGS. 7A and 7B are diagrams illustrating a basic configuration of a sheet binding unit according to another embodiment of the present disclosure;

FIGS. 8A and 8B are diagrams illustrating a basic configuration of a sheet binding unit according to yet another embodiment of the present disclosure;

FIGS. 9A, 9B and 9C are schematic diagrams each illustrating a configuration of a stapling unit;

FIGS. 10A and 10B are schematic diagrams each illustrating a configuration of a crimp binding unit;

FIG. 11 is a diagram illustrating a configuration of a sheet binding unit according to an embodiment;

FIGS. 12A, 12B, 12C and 12D are diagrams illustrating examples of images to be selected or generated as a determination result in the sheet binding unit;

FIGS. 13A and 13B are schematic diagrams each illustrating relative positions of a short-side sensor, a long-side sensor and an executable position;

FIGS. 14A and 14B are the sections of a flowchart of a first example of a process executable in the sheet binding unit;

FIG. 15 is a diagram illustrating a configuration of a sheet binding unit according to an embodiment of the present disclosure;

FIGS. 16A, 16B, 16C and 16D are diagrams each illustrating different examples of images to be selected or generated as a determination result in the sheet binding unit;

FIG. 17 is a flowchart of an example of a process flow for performing a manual binding operation by the sheet binding unit;

FIGS. 18A and 18B are the sections of a flowchart of a first modification of a process executable by the sheet binding unit;

FIGS. 19A and 19B are the sections of a flowchart of a second modification of a process executable by the sheet binding unit;

FIGS. 20A and 20B are the sections of a flowchart of a third modification of a process executable by the sheet binding unit;

FIG. 21 is a flowchart of a second example of a process executable by the sheet binding unit;

FIG. 22 is a diagram illustrating another example of a configuration of a sheet binding unit according to an embodiment of the present disclosure;

FIGS. 23A, 23B, 23C and 23D are diagrams illustrating examples of light emission patterns selected as a determination result by the sheet binding unit;

FIGS. 24A and 24B are the sections of a flowchart of a third example of a process executable by the sheet binding unit;

FIG. 25 is a diagram illustrating yet another example of a configuration of a sheet binding unit according to an embodiment of the present disclosure;

FIGS. 26A, 26B, 26C and 26D are diagrams illustrating examples of sound output patterns selected as a determination result by the sheet binding unit;

FIG. 27 is a diagram illustrating yet another example of a configuration of a sheet binding unit according to an embodiment of the present disclosure;

FIG. 28 is a diagram illustrating a determination table used in the sheet binding unit;

FIGS. 29A, 29B, 29C, 29D and 29E are diagrams illustrating examples of images to be selected or generated as a determination result in the sheet binding unit;

FIG. 30 is a flowchart of a fourth example of a process executable by the sheet binding unit;

FIGS. 31A, 31B and 31C are diagrams illustrating examples of light emission patterns selected as a determination result by the sheet binding unit;

FIGS. 32A, 32B and 32C are diagrams illustrating examples of sound output patterns selected as a determination result by the sheet binding unit; and

FIG. 33 including FIGS. 33A and 33B is a diagram illustrating a modification of a functional block of an image forming system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items. Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

### Embodiment of Image Forming Apparatus

A description is given below of an image forming apparatus according to the present disclosure with reference to the drawings.

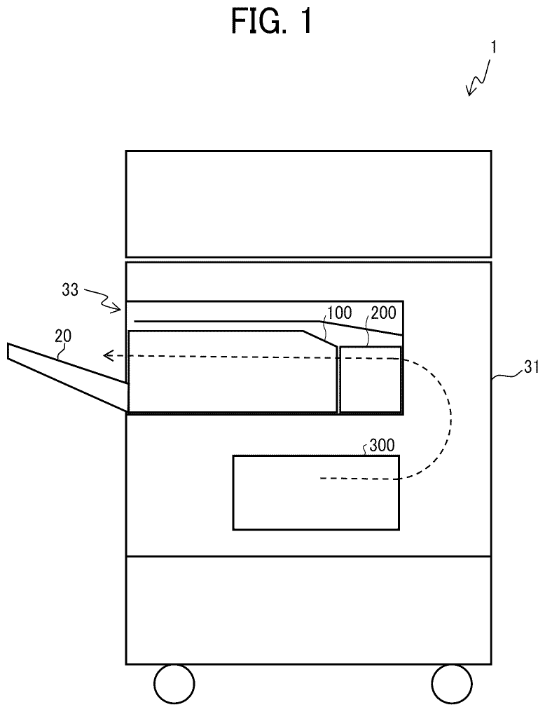

FIG. 1 is an external view of an image forming system 1 according to an embodiment of the present disclosure.

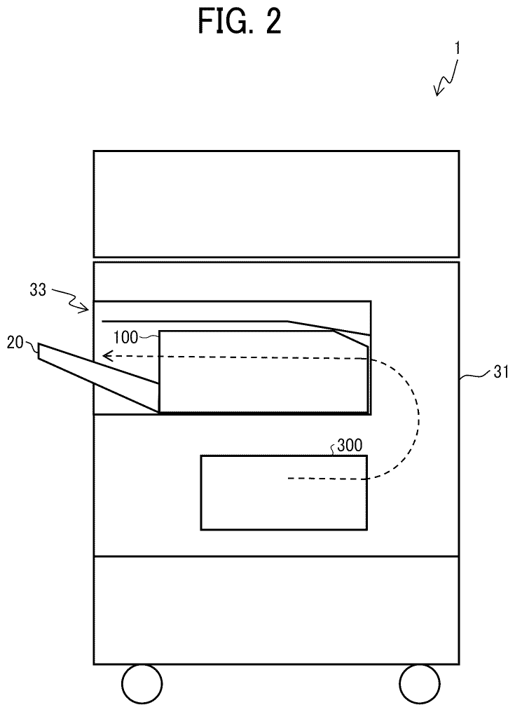

FIG. 2 is an external view of an image forming system 1 according to another embodiment of the present disclosure.

The image forming system 1 has an image forming function of forming an image on a sheet medium that is an object on which a post-processing operation is performed, and a post-processing function of performing a given post-processing operation (sheet processing) on the sheet medium on which an image is formed.

A sheet medium includes various types of media, and the following description employs a sheet of paper (sheet) as a sheet medium. A sheet of paper as an object on which the sheet processing is performed is referred to as a “sheet S” below.

As illustrated in FIG. 1, the image forming system 1 includes a housing 31 and an image forming device 300 that corresponds to an image forming apparatus disposed in the housing 31. The housing 31 has a box-shaped member having an inner space to accommodate the components of the image forming system 1. The housing 31 has an in-body space 33 that is accessible from the outside of the image forming system 1. The in-body space 33 is located, for example, slightly above the center of the housing 31 in the vertical direction. The in-body space 33 is exposed to the outside through the cutting that is made by cutting out the outer wall of the housing 31.

A punching unit 200 that can perform a punching operation or a sheet binding unit 100 that can perform a sheet binding operation to bundle and bind multiple sheets S can be attached as an optional unit to add an optional operation to the in-body space 33. The sheet binding unit 100 corresponds to an embodiment of a medium processing apparatus according to the present disclosure.

The image forming device 300 receives a sheet S that is picked up and conveyed from a sheet tray and ejects the sheet S to the punching unit 200 and the sheet binding unit 100. The image forming device 300 may be an inkjet system that forms an image using ink or an electrophotographic system that forms an image using toner. Since the image forming device 300 of FIG. 1 has a known configuration, a detailed description of the configuration and functions of the image forming device 300 is omitted.

The punching unit 200 is disposed in the in-body space 33 of the image forming system 1, and is located downstream from the image forming device 300 and upstream from the sheet binding unit 100 in a conveyance direction in a conveyance path of the sheet S from the image forming device 300 to the sheet binding unit 100. The conveyance path is indicated by a dashed line and an arrow in FIG. 1. In other words, in the image forming system 1, after the image forming device 300 has formed an image on the sheet S, the sheet S is conveyed to the punching unit 200 in which a given hole punching process is performed on the sheet S. Then, the sheet S is conveyed to the sheet binding unit 100 in which the sheet binding operation is performed on the sheet S.

The punching unit 200 is detachably attached to the image forming system 1.

When the punching unit 200 is removed, the state illustrated in FIG. 2 is obtained. After the image forming device 300 has formed an image on the sheet S, the sheet S is directly conveyed to the sheet binding unit 100 in which the sheet binding operation is performed. Another processing unit that performs any given process on the sheet S may be disposed in the in-body space 33 at the position from which the punching unit 200 is removed.

Configuration of Control Unit of Image Forming Apparatus with Medium Processing Apparatus

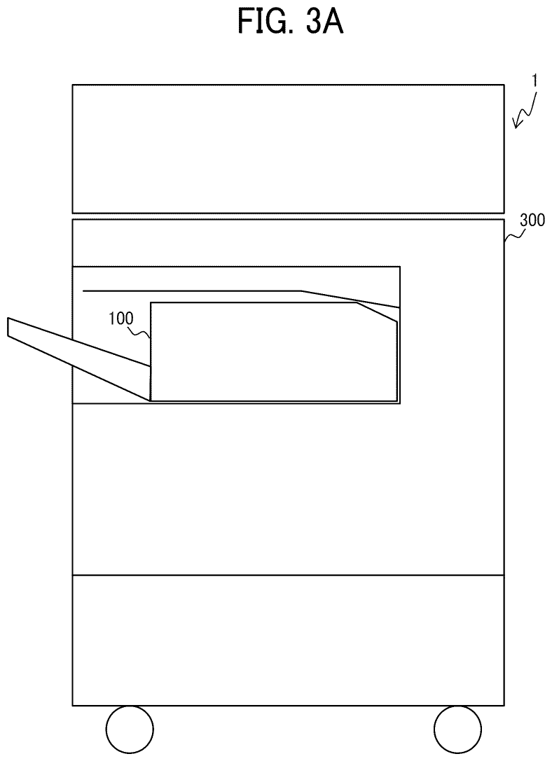

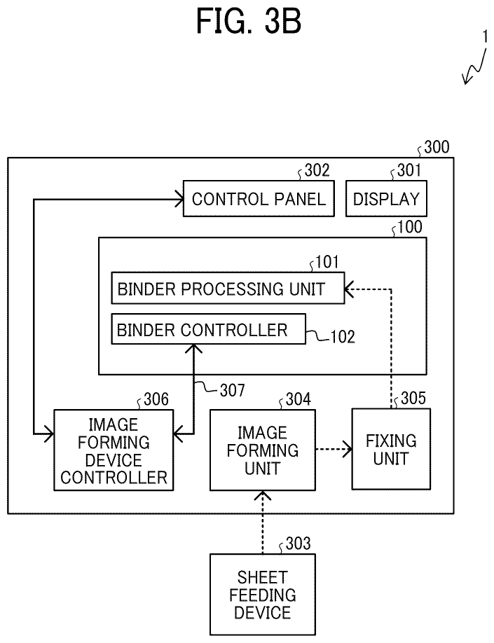

A description is now given of a configuration of a control unit of the image forming system 1 including the sheet binding unit 100, with reference to FIGS. 3A and 3B.

FIG. 3A is a diagram illustrating an example of a functional block of an image forming system 1 according to an embodiment of the present disclosure, when the punching unit 200 is removed.

FIG. 3B is a diagram illustrating an example of a structure of the image forming system 1 of FIG. 3A.

In FIGS. 3A and 3B, a conveyance path of the sheet S (flow of the sheet S) is indicated by an arrow in a broken line, and a path (flow of signals) of a communication signal (control signal) is indicated by an arrow in a solid line.

The image forming system 1 includes a display 301, a control panel 302, and a sheet feeding device 303. The display 301 notifies the user of the state of various devices and the operation contents of the image forming system 1. The control panel 302 allows the user to set, for example, an operation mode and the number of copies. The sheet feeding device 303 stocks sheets S and feeds the sheets S one by one. The image forming system 1 further includes an image forming unit 304 and a fixing device 305. The image forming unit 304 forms a latent image on a photoconductor and transfers the image to the sheet S. The fixing device 305 fixes the image transferred onto the sheet S. The image forming system 1 further includes an image forming device controller 306 that controls various operations of the devices and units described above.

In the sheet binding unit 100 as a sheet processing apparatus, the image forming device controller 306 of the image forming system 1 instructs, through a communication line 307, the binder controller 102 to cause a binder processing unit 101 to perform the designated process on the designated sheet S.

The image forming device controller 306 and the binder controller 102 are connected to each other via the communication line 307 to exchange information between the image forming device controller 306 and the binder controller 102. By so doing, information on, for example, the operation mode, the size of the sheet S, and the timing are exchanged to make the system operable.

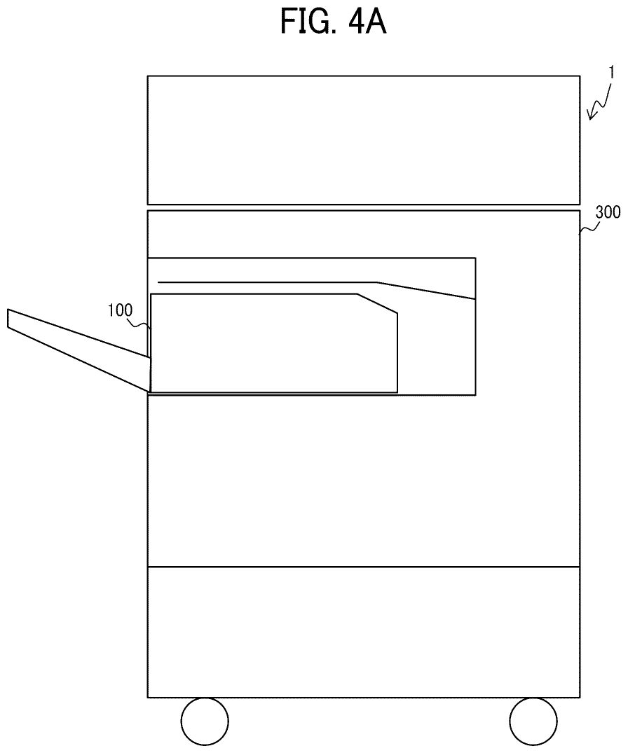

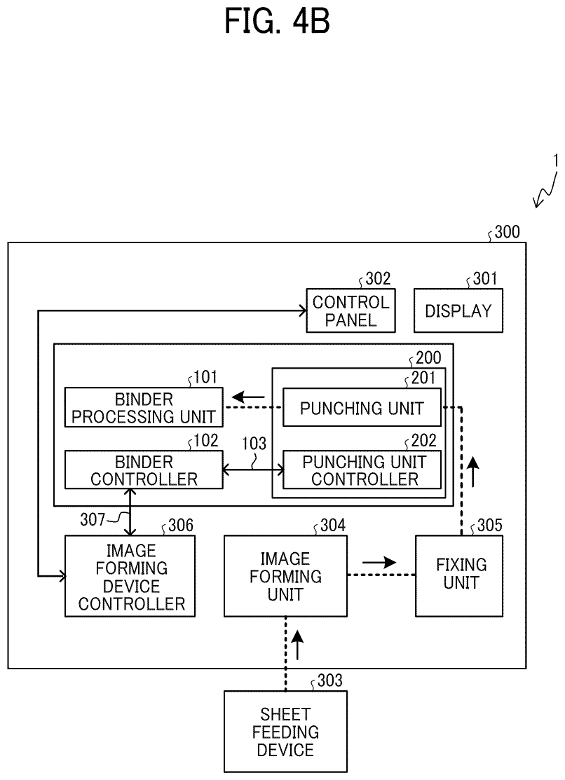

FIG. 4A is a diagram illustrating another example of a functional block of an image forming system 1 according to an embodiment of the present disclosure, when the punching unit 200 is removed.

FIG. 4B is a diagram illustrating another example of a structure of the image forming system 1 of FIG. 4A.

In FIGS. 4A and 4B, a conveyance path of the sheet S (flow of the sheet S) is indicated by an arrow in a broken line, and a path (flow of signals) of a communication signal (control signal) is indicated by an arrow in a solid line.

The image forming system 1 illustrated in FIGS. 4A and 4B has the same configuration as the image forming system 1 illustrated in FIGS. 3A and 3B, and includes the display 301, the control panel 302, and the sheet feeding device 303. The image forming system 1 further includes the image forming unit 304 and the image forming device controller 306.

In the sheet binding unit 100 as a sheet processing apparatus, the image forming device controller 306 of the image forming system 1 instructs, through a communication line 307, the binder controller 102 to cause a binder processing unit 101 to perform the designated process on the designated sheet S. The binder processing unit 101 is notified of designated information of process contents for the sheet S via a punching unit 201.

The image forming device controller 306 and the binder controller 102 are connected to each other via the communication line 307 to exchange information between the image forming device controller 306 and the binder controller 102. By so doing, information on, for example, the operation mode, the size of the sheet S, and the timing are exchanged to make the system operable.

In the punching unit 200, the image forming device controller 306 of the image forming system 1 instructs, through the communication line 307, the binder controller 102 to send the designated process on the designated sheet S from the binder controller 102 to a punching unit controller 202 through the communication line 103. The punching unit controller 202 controls the punching unit 201 to perform an instructed punching operation.

### Hardware Configuration of Image Forming System 1

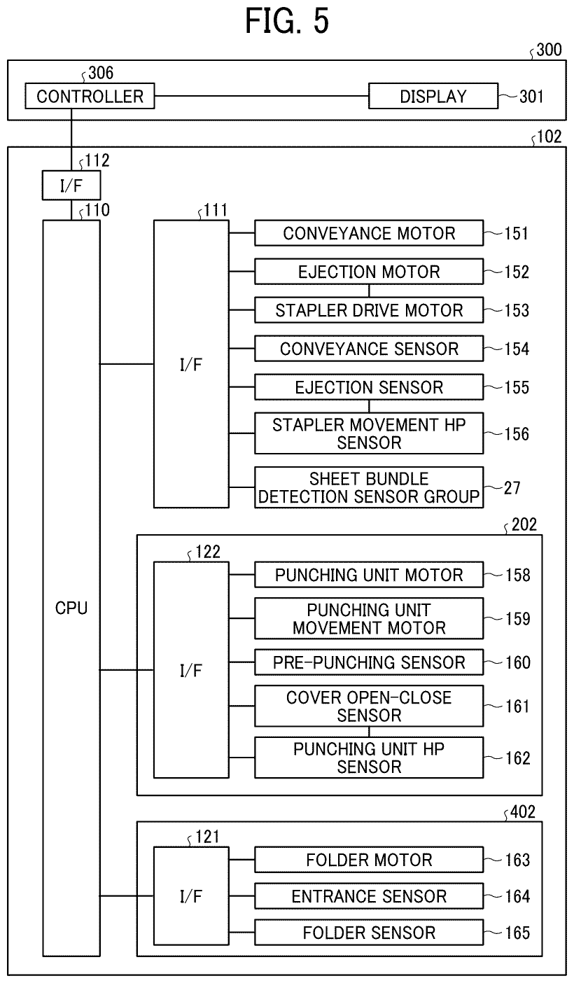

A description is given of a hardware configuration of the sheet binding unit 100 included in the image forming system 1, with reference to FIG. 5.

FIG. 5 is a diagram illustrating a functional block of the sheet binding unit 100 according to an embodiment of the present disclosure.

As illustrated in FIG. 5, the sheet binding unit 100 includes a central processing unit (CPU) 110 as a controller. The CPU 110 is connected to multiple motors as drive sources for the operations of the respective mechanisms via an interface (I/F) 111. The CPU 110 is a calculation unit and controls the entire operation of the sheet binding unit 100.

The CPU 110 in the sheet binding unit 100 is connected to the image forming device controller 306 of the image forming system 1 via an interface (I/F) 112 to control the sheet binding unit 100 in accordance with a processing signal from the image forming system 1. Since the sheet binding unit 100 is also an optional device, the hardware of the sheet binding unit 100 is detachable from the image forming system 1.

The interface portion in which the image forming device 300 and the sheet binding unit 100 are coupled to each other is mechanically detachable by, for example, a relay connector or a drawer connector. The interface portion in which the punching unit 200 or a sheet folding unit 400 and the image forming device 300 are coupled to each other is also mechanically detachable by, for example, a relay connector or a drawer connector.

The drive motors for driving multiple conveyance roller pairs to perform the sheet binding process in the sheet binding unit 100 has encoders that can detect the amount of driving force of each motor based on the number of pulses. Accordingly, the image forming system 1 can cause the conveyance roller pairs to be driven and stopped at respective positions of each specific driving amount from a specific timing as a starting point, and can achieve the control for conveying the sheet S in a given direction by a given amount.

Further, the encoder pulse is measured with the timing at which the sensor on the conveyance passage is on or off as a base point, and the driving amount of each motor can be calculated based on the encoder pulse. Then, the position of the end of the sheet S being conveyed can be detected based on the calculated driving amount.

As illustrated in FIG. 5, in the binder controller 102 as a controller of the sheet binding unit 100, a sheet conveyance motor 151, a sheet ejection motor 152, a stapler drive motor 153, a sheet conveyance sensor 154, a sheet ejection sensor 155, a stapler home position (HP) sensor 156, and a sheet bundle detection sensor group 27 that is described below are connected to the CPU 110 via the I/F 111.

In a sheet folding controller 402 as a controller of the sheet folding unit 400, a folder motor 163, an entrance sensor 164 and a folder sensor 165 are connected to the CPU 110 via an interface (I/F) 121.

When the punching unit 200 that performs hole punching on a sheet S as an optional device is coupled to the punching unit controller 202, a punching unit motor 158, a punching unit movement motor 159, a pre-punching sensor 160, a cover open-close sensor 161, and a punching unit home position (HP) sensor 162 are connected to the CPU 110 via an interface (I/F) 122.

### Configuration of Sheet Binding Unit 100

A description is given below of the configuration of a sheet binding unit 100 according to the present embodiment, with reference to the drawings.

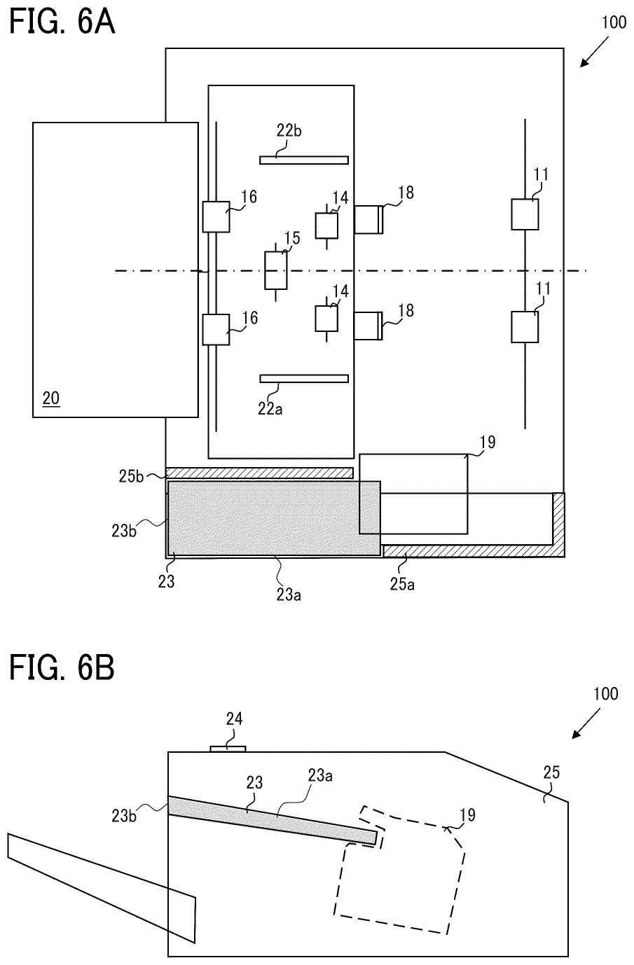

FIG. 6A is a plan view of the sheet binding unit 100.

FIG. 6B is a cross-sectional view of the sheet binding unit 100.

FIGS. 6A and 6B illustrate only the stapling unit 19 as the sheet binding unit 100 for “staple binding” for binding the end portion of a sheet bundle using a binding staple or staples.

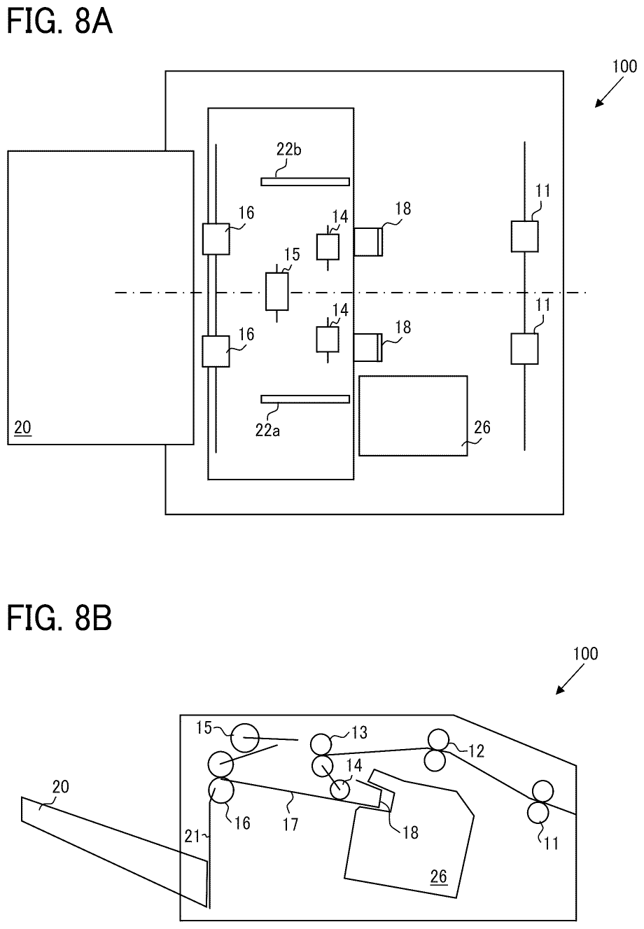

As described below, the binding unit that can be used for a manual binding operation (manual stapling) by the sheet binding unit 100 is not limited to the stapling unit 19. A crimp binding unit 26 (see FIGS. 8A and 8B) that can perform crimping binding of binding the sheet bundle Sb by deforming a part of the sheet bundle Sb by pressing without using a binding needle can also be used.

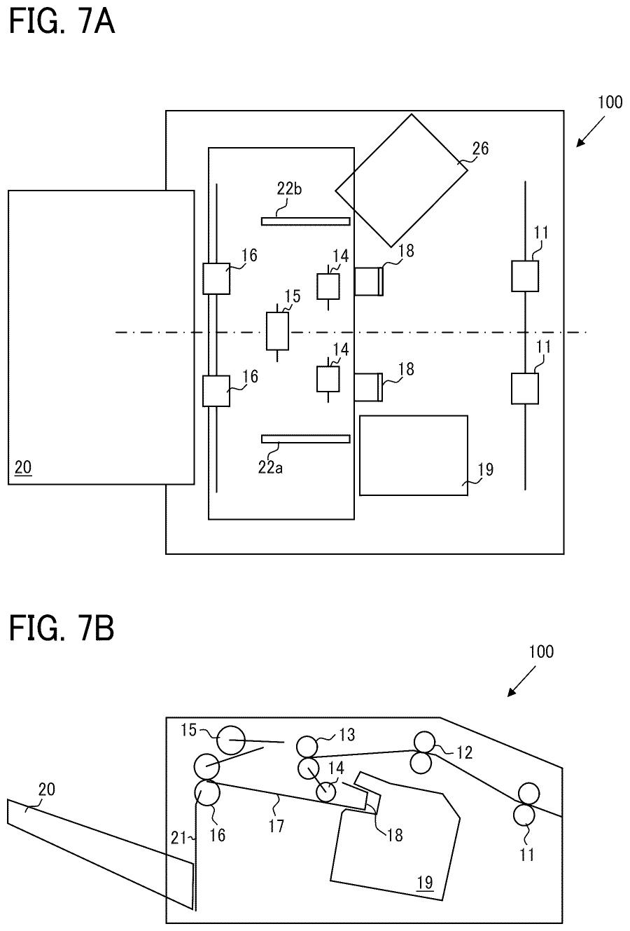

FIGS. 7A and 7B are diagrams illustrating a basic configuration of a sheet binding unit according to another embodiment of the present disclosure.

As illustrated in FIGS. 7A and 7B, the stapling unit 19 and the crimp binding unit 26 can be included in a hybrid configuration as a sheet binding unit.

FIGS. 8A and 8B are diagrams illustrating a basic configuration of a sheet binding unit according to yet another embodiment of the present disclosure.

As illustrated in FIGS. 8A and 8B, the sheet binding unit 100 may be constructed by the crimp binding unit 26 for “crimping binding” in which the end portion of the sheet bundle Sb is pressed and deformed to be bound without using the binding needle.

In other words, the sheet binding unit 100 described as an example in the following description may be applied to any of a sheet binding unit including only the stapling unit 19, a sheet binding unit including only the crimp binding unit 26, and a hybrid configuration including both of the units, regardless of whether or not the units are illustrated.

As illustrated in FIG. 6B, the sheet binding unit 100 includes an exterior 25 as a housing (part of the housing of the sheet binding unit 100). A slit 23 for manual stapling is mounted on the exterior 25. The slit 23 is a gap having a space into which a user can insert the sheet bundle Sb from opening 23a and 23b provided in a part of the exterior 25. The user inserts the sheet bundle Sb into the slit 23, and the sheet binding operation is performed in a state where the sheet bundle Sb is at an appropriate position, whereby the sheet binding operation is appropriately performed on the sheet bundle Sb. In FIGS. 7A, 7B, 8A and 8B, the configuration used for the manual stapling process including the slit 23 is omitted. The sheet binding unit 100 is settable with multiple operating modes and is appropriately performed based on a set operating mode. The operating modes of the sheet binding unit 100 includes, for example, a “shift ejection mode” in which no binding is performed on a sheet S before the sheet S is conveyed and ejected from the upstream side (image forming device 300) to the ejection tray 20 in the conveyance direction and a “binding mode” in which a sheet binding operation on the sheet S by the stapling unit 19 and the crimp binding unit 26.

In the shift ejection mode, the sheet S conveyed from the image forming device 300 is received by entrance roller pairs 11, and is conveyed to an ejection roller pair 16 before the sheet S is ejected to the ejection tray 20.

In the binding mode, the sheet S conveyed from the image forming device 300 is received by the entrance roller pairs 11, and is conveyed to the shift roller pair 13 in the first direction. When the sheet S passes through the shift roller pair 13, a hitting roller 15 is driven to stack the sheet S onto a sheet tray 17 as an internal tray. Then, the hitting roller 15 and the returning roller 14 move to convey the sheet S in a direction toward the terminal end of the sheet tray 17. At this time, the sheet S is conveyed toward a reference fence 18 for aligning the end portion of the sheet S.

In the binding mode, the above-described conveyance of the sheet S in the sheet tray 17 from the sheet tray 17 to the reference fence 18 is repeated until the number of sheets S becomes equal to the number of sheets to be bound. When the last sheet S is conveyed to the reference fence 18, a sheet binding unit such as the stapling unit 19 or the crimp binding unit 26 performs the sheet binding operation to bind the end portion of a bundle of sheets S (sheet bundle Sb). The sheet bundle Sb bound by the sheet binding unit (the stapling unit 19 or the crimp binding unit 26) is ejected by the ejection roller pair 16 to the ejection tray 20.

The sheet S or the sheet bundle Sb ejected to the ejection tray 20 is aligned by contacting an end of the sheet S or the sheet bundle Sb against an end fence 21.

The sheet bundle Sb is inserted into the slit 23, and the user presses an operation start button 24 mounted on a part of the exterior 25 of the sheet binding unit 100. By so doing, the stapling operation or the crimp binding operation is performed. The operation start button 24 corresponds to an operation unit for instructing the start of the manual binding operation.

The stapling unit 19 or the crimp binding unit 26 may set the binding position at which manual stapling is performed to be a home position (initial position). In other words, when the user inserts and sets the sheet bundle Sb in the slit 23, the position corresponding to the binding position for the sheet bundle Sb when the end portions of the sheets of the sheet bundle Sb contact the contact positions for positioning the sheet bundle can be set as a home position.

As a positioning structure of the sheet bundle Sb, the sheet binding unit 100 includes a regulator for regulating the position of the sheet bundle Sb inserted into the slit 23. A side in one direction among multiple sides forming the outer edge of the sheet bundle Sb is referred to as a first direction end. Further, another side of the multiple sides forming the outer edge of the sheet bundle Sb, which is a side in a direction orthogonal to the side in the one direction, is referred to as a second direction end. In a case where the sheet S has a rectangular shape, the short side corresponds to the first direction end and the long side corresponds to the second direction end.

As illustrated in FIG. 6A, the sheet binding unit 100 includes a conveyance direction stopper 25a and a width direction stopper 25b. The conveyance direction stopper 25a functions as a restrictor to restrict the position of the first direction end of the sheet bundle Sb inserted in the slit 23 as the first direction end of the sheet bundle Sb contacts the conveyance direction stopper 25a. Further, the width direction stopper 25b functions as a restrictor to restrict the position of the second direction end of the sheet bundle Sb inserted into the slit 23 as the second direction end of the sheet bundle Sb contacts the width direction stopper 25b. The positions of the conveyance direction stopper 25a and the width direction stopper 25b to which the sheet bundle Sb inserted in the slit 23 are adjusted so that the positions of the conveyance direction stopper 25a and the width direction stopper 25b are the binding positions that are appropriate to perform the sheet binding operation on the sheet bundle Sb.

The home position of the sheet binding unit 100 is set so that the sheet binding operation is performed on the sheet bundle Sb at the positions of the ends of the sheet bundle Sb when the sheet bundle Sb contacts the conveyance direction stopper 25a and the width direction stopper 25b. By performing these settings, the manual stapling can be performed at the position at the start of operation of the sheet binding unit 100.

In the example illustrated in FIGS. 7A and 7B, the crimp binding unit 26 is disposed on the far side of the sheet binding unit 100 and the stapling unit 19 is disposed on the near side (front side) of the sheet binding unit 100. However, the positions of the crimp binding unit 26 and the stapling unit 19 are not limited to these positions. For example, the stapling unit 19 may be disposed on the far side of the sheet binding unit 100 and the crimp binding unit 26 may be disposed on the near side (front side) of the sheet binding unit 100.

The “far side” used in this specification corresponds to the opposite side of the near side (front side) when the long side of the sheet S is the near side (front side) to the opening of the slit 23 into which the sheet bundle Sb is inserted. In other words, the “far side” corresponds to the upper side of the drawing sheet when facing the drawing sheet of FIG. 6A.

### Configuration of Stapling Unit 19

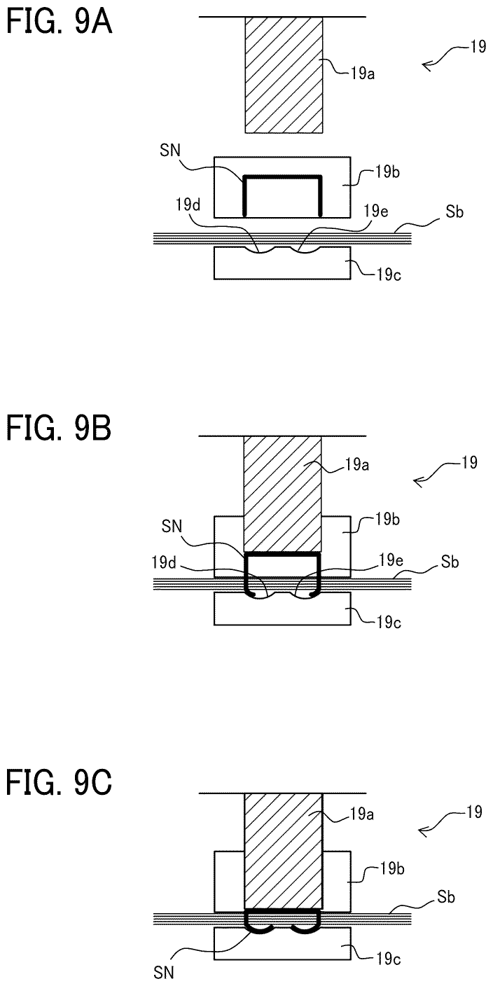

FIGS. 9A, 9B and 9C are schematic diagrams each illustrating a configuration of the stapling unit 19.

The stapling unit 19 includes a driver 19a, a staple container 19b, and a clincher 19c. The staple container 19b contains staples (binding needles) SN. The clincher 19c is a bending base having grooves 19d and 19e formed for guiding the tip end portions of the staples SN to the inner side. The clincher 19c is positioned below the staple container 19b.

As illustrated in FIG. 9A, in the stapling operation, the sheet bundle Sb placed on the sheet tray 17 (see FIG. 8B) is inserted between the clincher 19c and the staple container 19b.

Then, as illustrated in FIG. 9B, the stapler drive motor 153 (see FIG. 5) is driven to move the driver 19a downward toward the staple container 19b. As the driver 19a lowers, the staple SN is pushed out downward from the inside of the staple container 19b. Thus, the staple SN penetrates the sheet bundle Sb.

As illustrated in FIG. 9C, the staple SN penetrating the sheet bundle Sb is bent inward by being pressed against the grooves 19d and 19e of the clincher 19c. Thus, the sheet bundle Sb is bound by the staple SN.

### Configuration of Crimp Binding Unit 26

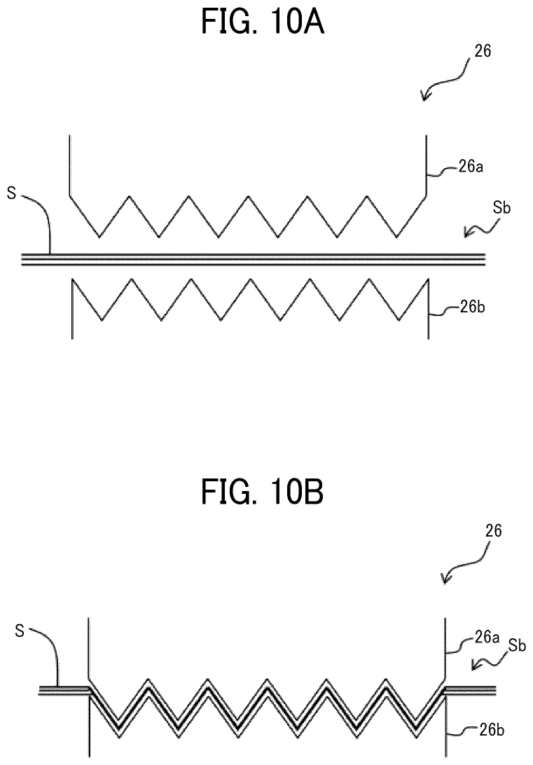

FIGS. 10A and 10B are schematic diagrams each illustrating a configuration of the crimp binding unit 26.

As illustrated in FIGS. 10A and 10B, the crimp binding unit 26 includes a pair of binding teeth, which are an upper crimping teeth 26a and a lower crimping teeth 26b.

The pair of binding teeth, which are the upper crimping teeth 26a and the lower crimping teeth 26b, are disposed facing each other in the thickness direction of the sheet bundle Sb to nip the sheet bundle Sb placed on the sheet tray 17 (see FIG. 8B). The upper crimping teeth 26a and the lower crimping teeth 26b in a pair have respective serrate faces facing each other. The serrate face of each of the upper crimping teeth 26a and the lower crimping teeth 26b includes concave portions and convex portions alternately formed. The concave portions and the convex portions of the upper crimping teeth 26a are shifted from the concave portions and the convex portions of the lower crimping teeth 26b such that the upper crimping teeth 26a are engaged with the lower crimping teeth 26b. The upper crimping teeth 26a and the lower crimping teeth 26b are brought into contact with and separated from each other by the driving force of a stapler drive motor 153 illustrated in FIG. 5.

In the process of supplying the multiple sheets S of the sheet bundle Sb to the sheet tray 17, the upper crimping teeth 26a and the lower crimping teeth 26b are separated from crimping teeth 26b as illustrated in FIG. 10A.

When all the sheets S of the sheet bundle Sb are placed on the sheet tray 17, the upper crimping teeth 26a and the lower crimping teeth 26b are engaged with each other to press and deform the sheet bundle Sb in the thickness direction as illustrated in FIG. 10B. As a result, the sheet bundle Sb that has been placed on the sheet tray 17 is crimped and bound. The sheet bundle Sb thus crimped and bound is ejected to the ejection tray 20 by the ejection roller pair 16.

### First Embodiment of Sheet Binding Unit 100

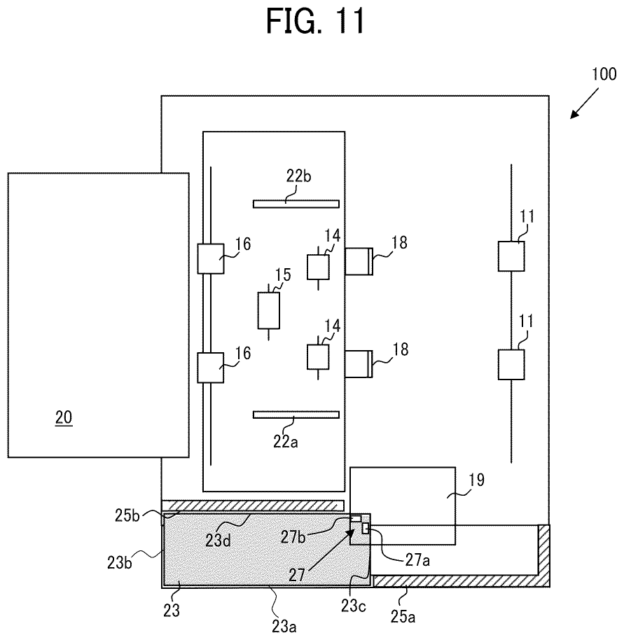

FIG. 11 is a diagram illustrating a configuration of the sheet binding unit 100 according to an embodiment.

FIG. 11 is a plan view of the sheet binding unit 100.

The position of the stapling unit 19 indicates a position of the end portion when the sheet bundle Sb is inserted in the slit 23 and contacts the conveyance direction stopper 25a and the width direction stopper 25b. In other words, FIG. 11 indicates the state where the manual binding operation can be immediately performed as soon as the sheet bundle Sb is inserted into the slit 23 and the sheet bundle Sb contacts the restrictor.

Further, the state where the first direction end and the second direction end of the sheet bundle Sb inserted in the slit 23 are contacted to respective restrictors is a state where the sheet bundle Sb is at an “executable position” of the sheet binding operation. In the following description, the first direction end is assumed to be the “short side” of the sheet S and the sheet bundle Sb. Further, the second direction end is assumed to be the “long side” of the sheet S and the sheet bundle Sb. In other words, when the sheet bundle Sb is inserted toward the position in a direction where the stapling unit 19 performs the sheet binding operation, the position where the short side of the sheet bundle Sb contacts the conveyance direction stopper 25a is referred to as a short-side contact position, and the position where the long side of the sheet bundle Sb contacts the width direction stopper 25b is referred to as a long-side contact position.

The slit 23 is provided with a sheet bundle detection sensor group 27 that can detect the position of the sheet bundle Sb inserted in the slit 23, in other words, whether the sheet bundle Sb is in contact with a restrictor. The sheet bundle detection sensor group 27 is a group of at least two sensors, which are a short-side sensor 27a and a long-side sensor 27b (first sensor and second sensor). The slit 23 has a rectangular shape in a plan view. The side of the slit 23 facing the conveyance direction stopper 25a is defined as a short side 23c. The side of the slit 23 facing the width direction stopper 25b is referred to as a long side 23d.

The short-side sensor 27a is disposed on the short side 23c of the slit 23 or in the vicinity of the short side 23c. The short-side sensor 27a detects that the sheet bundle Sb contacts the conveyance direction stopper 25a. The short-side sensor 27a outputs the detection signal to the CPU 110.

The long side sensor 27b is disposed on the long side 23d of the slit 23 or in the vicinity of the long side 23d. The long side sensor 27b detects that the sheet bundle Sb contacts the width direction stopper 25b. The long side sensor 27b outputs a detection signal to the CPU 110.

The CPU 110 is an example of a determination unit. The CPU 110 determines the position information of the sheet bundle Sb inside the slit 23 according to the detection signals of the short-side sensor 27a and the long-side sensor 27b. The short-side sensor 27a and the long-side sensor 27b may be any type of sensor such as a transmission type sensor or a reflection type sensor as long as the sensor can detect whether the sheet bundle Sb exists in the detection range.

When determining the position information of the sheet bundle Sb in the slit 23, the CPU 110 determines the position information based on the detection signal from the short-side sensor 27a and the detection signal from the long-side sensor 27b. In other words, the short-side sensor flag is turned ON when the detection signal is input from the short-side sensor 27a, and the long-side sensor flag is turned ON when the detection signal is input from the long-side sensor 27b. Then, depending on the combination of ON and OFF of the two sensor flags, the CPU 110 determines the position information that indicates the position (state) of the sheet bundle Sb inserted in the slit 23. In other words, since the CPU 110 determines multiple pieces of position information based on the combination of the ON and

OFF states of the two sensor flags, the CPU 110 selects the position information corresponding to the combination of the ON and OFF states of the two sensor flags.

In the present embodiment, the position information selected by the CPU 110 according to the determination result (detection result) is information that can be notified by the notification device. For example, if an example of the notification device is the display 301, the CPU 110 selects an image corresponding to the position information and outputs the selected image to the display 301 so that the selected image can be displayed on the display 301. The images that can be outputted by the CPU 110 are stored in advance in the memory, and an image corresponding to the combination of the two sensor flags is selected and extracted from the memory. The images stored in the memory are at least three types or more in order to correspond to combinations of two sensor flags. An image that matches the determination result may be called from the memory and selected after the condition is determined, or an image that matches the determination result of the CPU 110 may be generated after the condition is determined.

When the CPU 110 determines the position information of the sheet bundle Sb, the CPU 110 sends an instruction to output an image as the selected or generated position information to the image forming device controller 306. The image forming device controller 306 sends an instruction to output the image selected or generated by the CPU 110 to the display 301, and causes the display 301 to display the image.

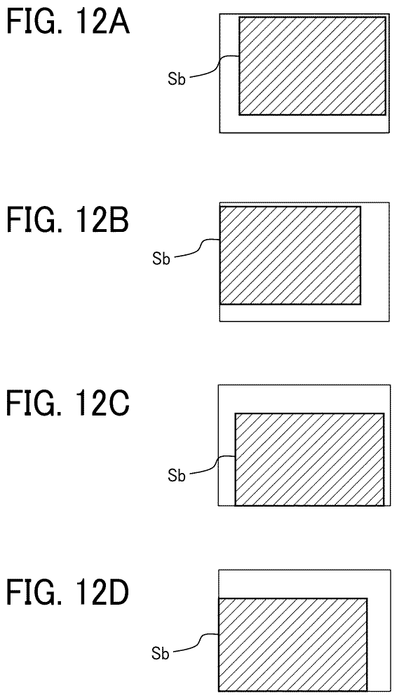

In the present embodiment, the images selected or generated by the CPU 110 as the determination result are four patterns illustrated in FIGS. 12A, 12B, 12C and 12D. FIG. 12A illustrates the first image GA when both the short-side sensor flag and the long-side sensor flag are ON.

FIG. 12A illustrates the state where the sheet bundle Sb reaches both the short-side contact position and the long-side contact position.

FIG. 12B illustrates the second image GB when both the short-side sensor flag is OFF, and the long-side sensor flag is ON.

FIG. 12B illustrates the state where the sheet bundle Sb does not reach the short-side contact position but reaches the long-side contact position.

FIG. 12C illustrates the third image GC when the short-side sensor flag is ON, and the long-side sensor flag is OFF.

FIG. 12C illustrates the state where the sheet bundle Sb reaches the short-side contact position but does not reach the long-side contact position.

FIG. 12D illustrates the fourth image GD when both the short-side sensor flag and the long-side sensor flag are OFF.

FIG. 12D illustrates the state where the sheet bundle Sb does not reach the short-side contact position and the long-side contact position.

Positional Relationship of Short-Side Sensor 27a, Long-Side Sensor 27b, and Executable Position P

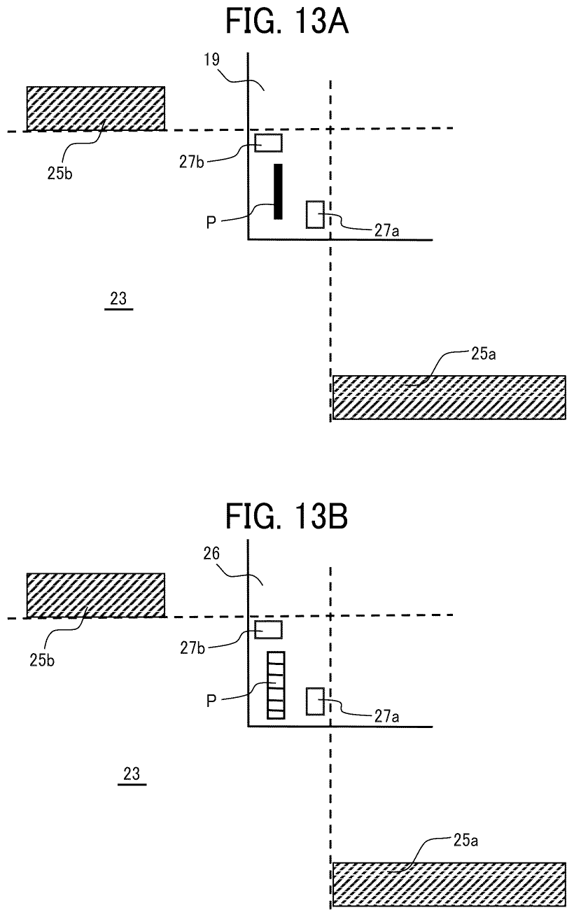

FIGS. 13A and 13B are schematic diagrams each illustrating the relative positions of the short-side sensor 27a, the long-side sensor 27b, and the executable position P.

More specifically, FIG. 13A illustrates the relative positions of the short-side sensor 27a, the long-side sensor 27b, and the executable position P at which the stapling unit 19 can perform the sheet binding operation on the sheet bundle Sb. The executable position P of FIG. 13A is a position at which the staple SN illustrated in FIGS. 9A, 9B and 9C passes through the sheet bundle Sb. Further, the executable position P of FIG. 13A may be a position at which the staple SN of the stapling unit 19 faces the sheet bundle Sb when the sheet bundle Sb is bundled. The positions of the short-side sensor 27a and the long-side sensor 27b may be downstream from the executable position P in the insertion direction of the sheet bundle Sb. The short-side sensor 27a and the long-side sensor 27b are located closer to the housing 31 than the binding position of the stapling unit 19 in the slit 23.

FIG. 13B illustrates the relative positions of the short-side sensor 27a, the long-side sensor 27b, and the executable position P at which the crimp binding unit 26 can perform the sheet binding operation on the sheet bundle Sb.

The executable position P of FIG. 13A is a position at which the upper crimping teeth 26a and the lower crimping teeth 26b illustrated in FIG. 10 can crimp the sheet bundle Sb. Further, the executable position P of FIG. 13A may be a position at which the upper crimping teeth 26a and the lower crimping teeth 26b of the crimp binding unit 26 face the sheet bundle Sb when the sheet bundle Sb is bundled.

As illustrated in FIGS. 13A and 13B, the short-side sensor 27a is disposed on the base end side (the side where the opening 23a is located) in the conveyance direction to the conveyance direction stopper 25a in the conveyance direction. The short-side sensor 27a is located farther from the housing 31 than the conveyance direction stopper 25a. The long-side sensor 27b is disposed on the near side (front side) in the width direction (the side where the opening 23b is located) to the width direction stopper 25b. The long-side sensor 27b is located farther from the housing 31 than the width direction stopper 25b. The executable position P is disposed on the base end side in the conveyance direction with respect to the short-side sensor 27a in the conveyance direction, and is disposed on the near side (front side) in the width direction to the long-side sensor 27b in the width direction.

### Process Flow in Sheet Binding Unit 100 (First Example)

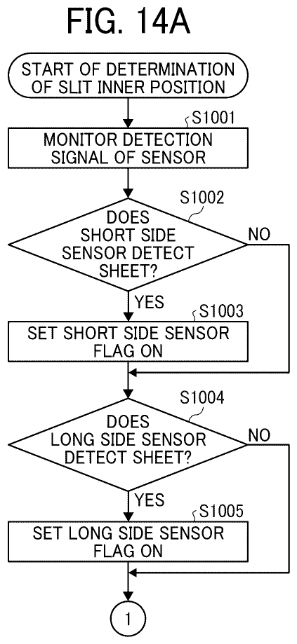

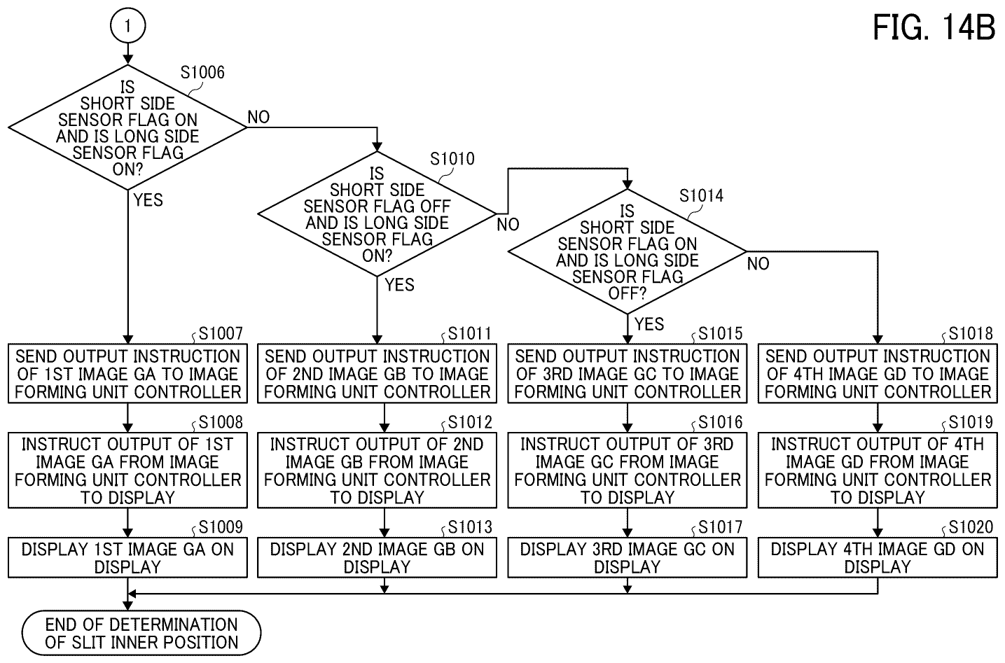

A description is now given of the first example of the process flow of a control processing program executed in the sheet binding unit 100, with reference to the flowchart of FIGS. 14A and 14B.

FIGS. 14A and 14B are the sections of a flowchart of a first example of a process executable in the sheet binding unit 100.

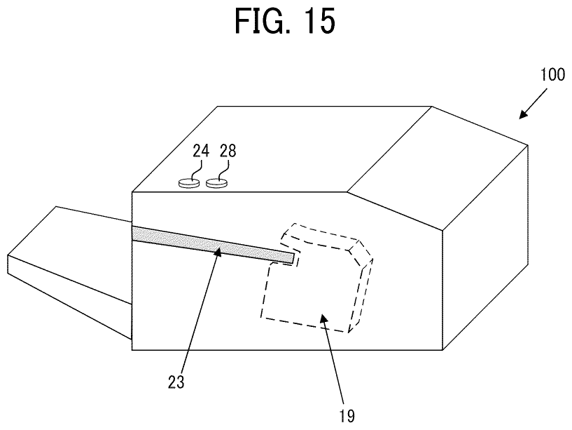

The flowchart of FIGS. 14A and 14B is an example of the process in which the CPU 110 of the sheet binding unit 100 determines the position of the sheet bundle Sb inside the slit 23 and notifies the determination result (detection result) in the manual stapling operation. FIG. 15 is an external view of the sheet binding unit 100 according to an embodiment of the present disclosure.

The sheet binding unit 100 includes a slit interior check button 28 that is pressed when the position of the sheet bundle Sb inside the slit 23 is checked. The slit interior check button 28 is mounted on a part of the exterior 25 of the sheet binding unit 100. The position where the slit interior check button 28 is arranged is, for example, in the vicinity of the operation start button 24.

A slit internal position determination process illustrated in the flowchart of FIGS. 14A and 14B is a process that starts, for example, at the timing when the slit interior check button 28 is pressed. At the start of the slit internal position determination process, both the short-side sensor flag and the long-side sensor flag are OFF.

In step S1001, when the CPU 110 starts the slit internal position determination process, the CPU 110 executes a process of monitoring the detection signals of the short-side sensor 27a and the long-side sensor 27b.

Under the monitoring process of step S1001, the CPU 110 determines whether there is a detection signal indicating that the short-side sensor 27a has detected the sheet S in step S1002.

When there is a detection signal indicating that the short-side sensor 27a has detected the sheet S (YES in step S1002), the CPU 110 turns the short-side sensor flag to ON in step S1003. On the other hand, when there is no detection signal indicating that the short-side sensor 27a has detected the sheet S (NO in step S1002), the short-side sensor flag remains in OFF.

In step S1004, the CPU 110 determines information of whether there is a detection signal indicating that the long-side sensor 27b has detected the sheet S. When there is a detection signal indicating that the long-side sensor 27b has detected the sheet S (YES in step S1004), the CPU 110 turns the long-side sensor flag to ON in step S1005. On the other hand, when there is no detection signal indicating that the long-side sensor 27b has detected the sheet S (NO in step S1004), the long-side sensor flag remains in OFF.

Then, the CPU 110 executes a process of selecting an image to be output to the display 301 based on the combination of ON and OFF of the two sensor flags, which are the short-side sensor flag and the long-side sensor flag.

When both the short-side sensor flag and the long-side sensor flag are ON (YES in step S1006), the CPU 110 selects the first image GA as a determination result (see FIG. 12A) and sends the output instruction of the first image GA to the image forming device controller 306 (step S1007). In step S1008, the image forming device controller 306 that has received the output instruction from the CPU 110 sends an instruction to output the first image GA to the display 301. In step S1009, the image forming device controller 306 that has received the output instruction from the CPU 110 sends an instruction to output the first image GA to the display 301. As a result, the user can recognize that the sheet bundle Sb has reached the short-side contact position and the long-side contact position. In other words, the user can recognize that the sheet bundle Sb is at the executable position where the sheet binding operation can be performed on the sheet bundle Sb inside the slit 23.

When the short-side sensor flag is OFF and the long-side sensor flag is ON (NO in step S1006 and YES in step S1010), the CPU 110 selects the position information of the second image GB as a determination result (see FIG. 12B) and sends the output instruction of the second image GB to the image forming device controller 306 (step S1011). In step S1012, the image forming device controller 306 that has received the output instruction from the CPU 110 sends an instruction to output the second image GB to the display 301. In step S1013, the display 301 that has received the output instruction from the image forming device controller 306 sends an instruction to output the second image GB to the display 301. As a result, the user can recognize that the sheet bundle Sb has not reached the short-side contact position but has reached the long-side contact position.

When the short-side sensor flag is ON and the long-side sensor flag is OFF (NO in step S1006, NO in step S1010, and YES in step S1014), the CPU 110 selects the position information of the third image GC as a determination result (see FIG. 12C) and sends the output instruction of the third image GC to the image forming device controller 306 (step S1015). In step S1016, the image forming device controller 306 that has received the output instruction from the CPU 110 sends an instruction to output the third image GC to the display 301. In step S1017, the display 301 that has received the output instruction from the image forming device controller 306 sends an instruction to output the third image GC to the display 301. As a result, the user can recognize that the sheet bundle Sb has reached the short-side contact position but has not reached the long-side contact position.

When both the short-side sensor flag and the long-side sensor flag are OFF (NO in steps S1006, S1010, and S1014), the CPU 110 selects the position information of the fourth image GD as a determination result (see FIG. 12D) and sends the output instruction of the fourth image GD to the image forming device controller 306 (step S1018). In step S1019, the image forming device controller 306 that has received the output instruction from the CPU 110 sends an instruction to output the fourth image GD to the display 301. In step S1020, the display 301 that has received the output instruction from the image forming device controller 306 sends an instruction to output the fourth image GD to the display 301. As a result, the user can recognize that the sheet bundle Sb has not reached the short-side contact position and the long-side contact position. After displaying any one of the first image GA, the second image GB, the third image GC and the fourth image GD, the CPU 110 ends the slit internal position determination process.

According to the present embodiment described above, the state of the sheet bundle Sb inside the slit 23 can be recognized from the image displayed on the display 301. Then, in a case where the sheet bundle Sb is at the executable position at which the sheet binding operation can be performed, from the first image GA displayed on the display 301, as the user presses the operation start button 24, the sheet binding operation in which the end portion of the sheet bundle Sb is bound is performed. On the other hand, in a case where the sheet bundle Sb is not at the executable position from the second image GB displayed on the display 301, the third image GC and the fourth image GD, the user can modify the position of the sheet bundle Sb. Then, after the position of the sheet bundle Sb is corrected, the user can press the slit interior check button 28 again to recognize the state of the sheet bundle Sb inside the slit 23.

The start of the slit internal position determination process is not limited to the timing when the slit interior check button 28 is pressed. For example, the CPU 110 may constantly monitor the detection signals of the short-side sensor 27a and the long-side sensor 27b, and may start the slit internal position determination process when either one of the short-side sensor 27a and the long-side sensor 27b outputs the detection signal.

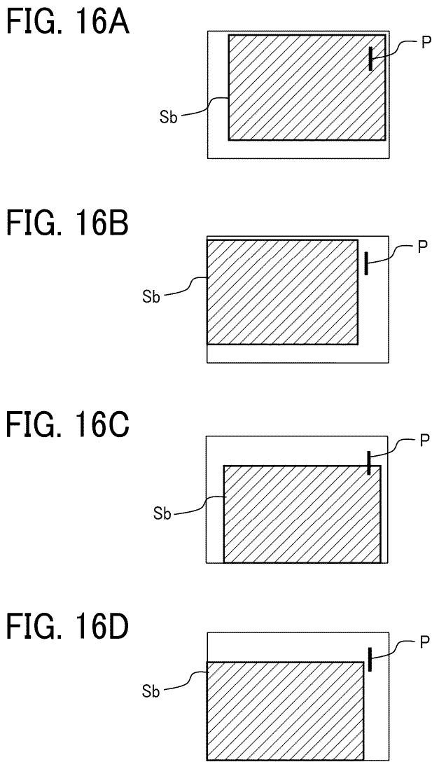

In addition, in a case where the CPU 110 performs the slit inner position determination, the selected or generated image is not limited to the first image GA to the fourth image GD illustrated in FIGS. 12A, 12B, 12C and 12D described above. For example, as illustrated in FIGS. 16A, 16B, 16C and 16D, the image selected or generated by the CPU 110 may be displayed on the display, and the executable position P at which the sheet binding operation can be performed on the sheet bundle Sb may be superimposed on the image. As a result, the user can recognize the state of the sheet bundle Sb inside the slit 23 more easily.

The executable position P is represented as a line or a rectangle in the first image GA, the second image GB, the third image GC and the fourth image GD, for example. In addition, the first image GA, the second image GB, the third image GC and the fourth image GD illustrated in FIGS. 16A, 16B, 16C and 16D, respectively, are the same as FIG. 16 is the same as the first image GA, the second image GB, the third image GC and the fourth image GD illustrated in FIGS. 12A, 12B, 12C and 12D, respectively, except that the executable position P is superimposed on the image selected or generated by the CPU 110. Accordingly, the detailed description of FIGS. 16A, 16B, 16C and 16D will be omitted.

FIG. 16A illustrates the first image GA when both the short-side sensor flag and the long-side sensor flag are ON. FIG. 16A indicates that the executable position P is at a position overlapping the sheet bundle Sb in both the conveyance direction and the width direction. The position overlapping the sheet bundle Sb is a position where the executable position P is entirely included within the range in which the sheet bundle Sb is located.

FIG. 16B illustrates the second image GB when both the short-side sensor flag is OFF, and the long-side sensor flag is ON. FIG. 16B indicates that the executable position P is at a position overlapping the sheet bundle Sb in the width direction and not overlapping the sheet bundle Sb in the conveyance direction. The position not overlapping the sheet bundle Sb is a position where at least a part of the executable position P is out of the range in which the sheet bundle Sb is located.

FIG. 16C illustrates the third image GC when the short-side sensor flag is ON, and the long-side sensor flag is OFF. FIG. 16C indicates that the executable position P is at a position not overlapping the sheet bundle Sb in the width direction and overlapping the sheet bundle Sb in the conveyance direction.

FIG. 16D illustrates the fourth image GD when both the short-side sensor flag and the long-side sensor flag are OFF. FIG. 16D indicates that the executable position P is at a position not overlapping the sheet bundle Sb in both the conveyance direction and the width direction.

Process Flow when Sheet Binding Unit 100 Performs Manual Binding Operation (Manual Stapling)

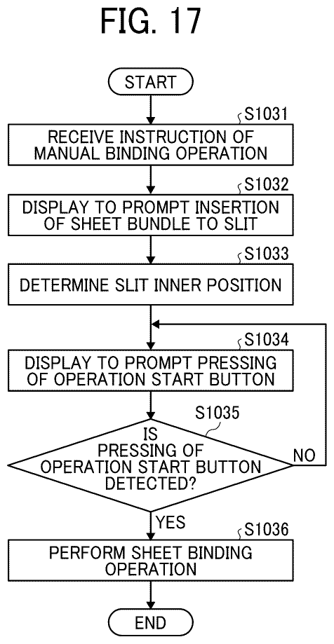

The flowchart illustrated in FIG. 17 is an example of the process flow in the sheet binding unit 100 from the start of the manual binding mode to the execution of the sheet binding operation. In step S1031, the CPU 110 changes the mode of the sheet binding unit 100 to the manual binding mode based on the setting operation of the user via the control panel 302. After the manual binding mode has started, the CPU 110 displays the content to prompt an insertion of the sheet bundle Sb to the slit 23 (for example, the message “Please insert a sheet bundle to the slit”) on the display 301, in step S1032.

In step S1033, after displaying the content, on the display 301, for prompting the insertion of the sheet bundle Sb into the slit 23, the CPU 110 executes the slit internal position determination process. In the slit internal position determination process in step S1033, the slit internal position determination process similar to each process (steps ST1001 to ST1020) of the flowchart illustrated in FIGS. 14A and 14B described above, in the modification example or each embodiment below is executed.

After the slit internal position determination process, the CPU 110 causes the display 301 to display the content to prompt a pressing of the operation start button 24 (for example, the message “Please press the operation start button”), in step S1034. Then, when the operation start button 24 is pressed (YES in step S1035), the CPU 110 causes the stapling unit 19 or the crimp binding unit 26 to perform the sheet binding operation, in step S1036. The manual binding mode is ended. Even if a given time has elapsed and the pressing of the operation start button 24 is not detected (NO in step S1035), the CPU 110 causes the display 301 to display the content to prompt a pressing of the operation start button 24 again, in step S1034.

### First Modification of Process Flow in Sheet Binding Unit 100

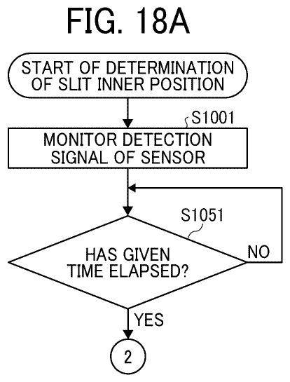

FIGS. 18A and 18B are the sections of a flowchart of a first modification of a process executable by the sheet binding unit 100.

In the process flow of the sheet binding unit 100 in the first example, the CPU 110 starts to monitor the detection signals of the short-side sensor 27a and the long-side sensor 27b (step S1001), determines whether there is the detection signals of the short-side sensor 27a and the long-side sensor 27b (steps S1002 to S1005), then selects an image to be output on the display 301. However, the process is not limited to the above-described process flow of the sheet binding unit 100. For example, in the process flow of the sheet binding unit 100 in the first modification illustrated in the flowchart of FIGS. 18A and 18B, it is not determined whether the two sensor flags (i.e., the short-side sensor flag and the long-side sensor flag) are ON or OFF from the timing when the CPU 110 starts to monitor the detection signals of the short-side sensor 27a and the long-side sensor 27b (step S1001) to the timing when the given time has elapsed (NO in step S1051).

Then, after the given time has elapsed (YES in step S1051), the CPU 110 determines whether the two sensor flags (i.e., the short-side sensor flag and the long-side sensor flag) are ON or OFF.

More specifically, in the first modification, when the CPU 110 determines whether both the short-side sensor flag and the long-side sensor flag are ON (step S1052), whether the short-side sensor flag is OFF and the long-side sensor flag is ON (step S1053), and whether the short-side sensor flag is ON and the long-side sensor flag is OFF (step S1054), the CPU 110 acquires the state of the detection signals of the short-side sensor 27a and the long-side sensor 27b (ON or OFF of the short-side sensor flag and the long-side sensor flag) to the determinations. As a result, even if the sheet bundle Sb moves after the start of monitoring the detection signals of the short-side sensor 27a and the long-side sensor 27b and before the given time elapses, the CPU 110 can determine the correct position of the sheet bundle Sb in the slit 23.

After the determinations (steps S1052 to S1054), the process of selecting an image to be output to the display 301 is the same as the process (steps S1007 to S1009, S1011 to S1013, S1015 to S1017, and S1018 to S1020) of the first example, and thus the description of the process will be omitted.

### Second Modification of Process Flow in Sheet Binding Unit 100

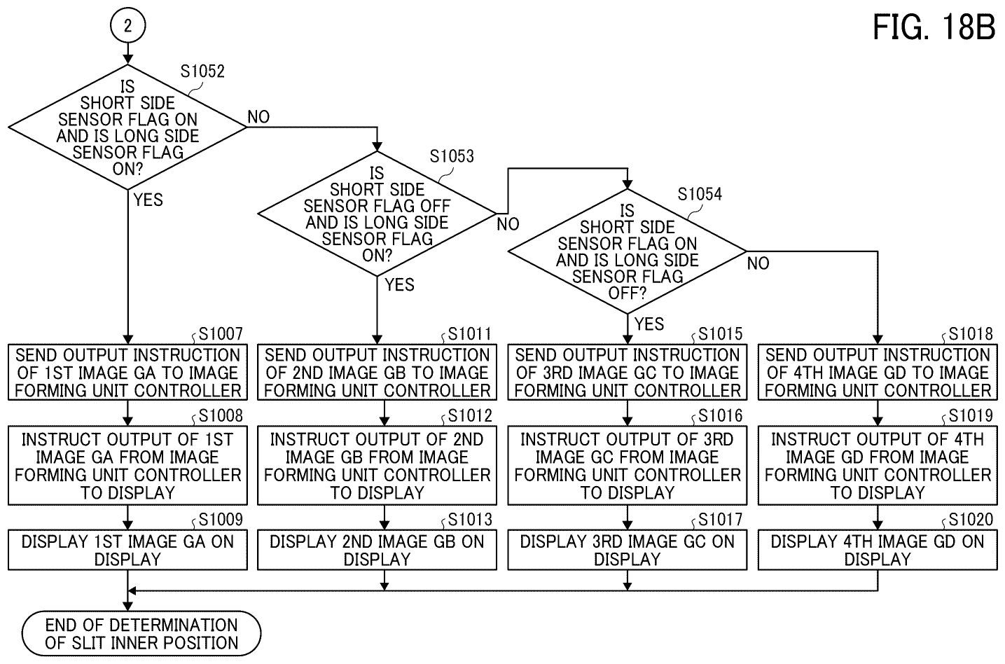

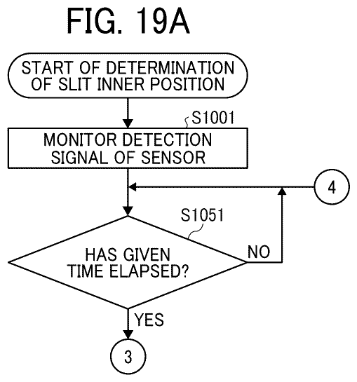

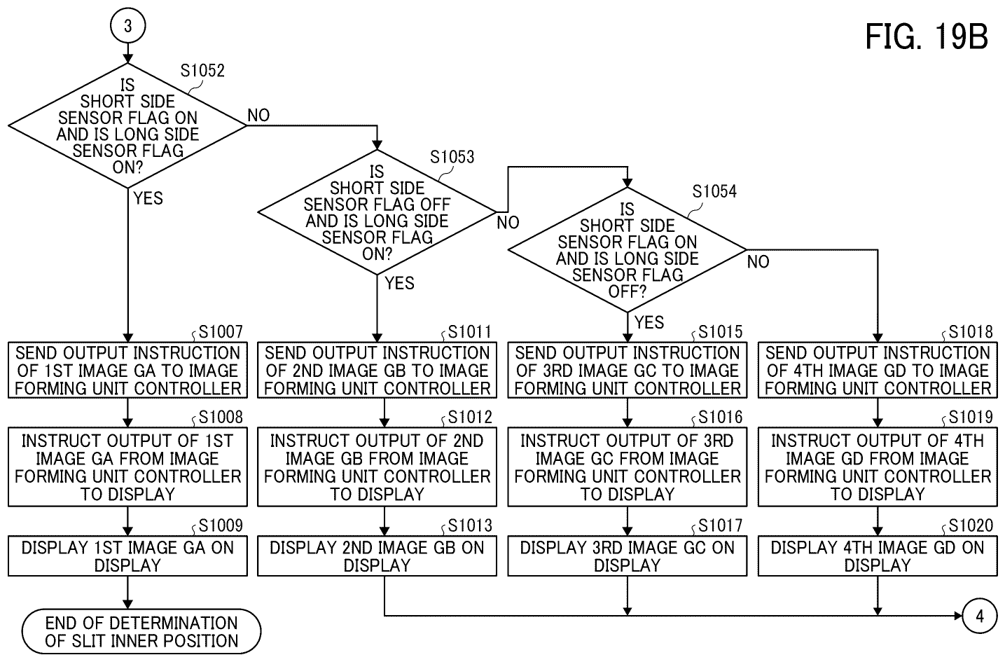

FIGS. 19A and 19B are the sections of a flowchart of a second modification of a process executable by the sheet binding unit 100.

In the process flow of the sheet binding unit 100 in the first example and the first modification, when the position of the sheet bundle Sb is deviated (in other words, when the sheet bundle Sb is not at the executable position), the CPU 110 causes the display 301 to display the second image GB, the third image GC and the fourth image GD (steps S1013, S1017 and S1020), and then ends the slit internal position determination process. However, the process is not limited to the above-described process flow of the sheet binding unit 100. For example, in the process flow of the sheet binding unit 100 in the second modification illustrated in the flowchart of FIGS. 19A and 19B, the CPU 110 causes the display 301 to display the second image GB, the third image GC and the fourth image GD (steps S1013, S1017 and S1020), then executes the process to monitor the detection signals of the short-side sensor 27a and the long-side sensor 27b again (step S1001). After the given time has elapsed (YES in step S1051), the CPU 110 determines the state of ON and OFF of the two sensor flags (the short-side sensor flag and the long-side sensor flag) (steps S1052 to S1054).

In other words, in the second modification, the CPU 110 repeats the above-described determination (steps S1052 to S1054) and the process of selecting an image to be output to the display 301 (steps S1007 to S1009, S1011 to S1013, S1015 to S1017, and S1018 to S1020) until the sheet bundle Sb comes to the correct position (the sheet bundle Sb is at the executable position) (step S1009). As a result, when the user confirms the display of the second image GB, the third image GC and the fourth image GD and corrects the position of the sheet bundle Sb to place the sheet bundle Sb at the correct position, the CPU 110 can end the slit internal position determination process and perform the sheet binding operation on the sheet bundle Sb.

### Third Modification of Process Flow in Sheet Binding Unit 100

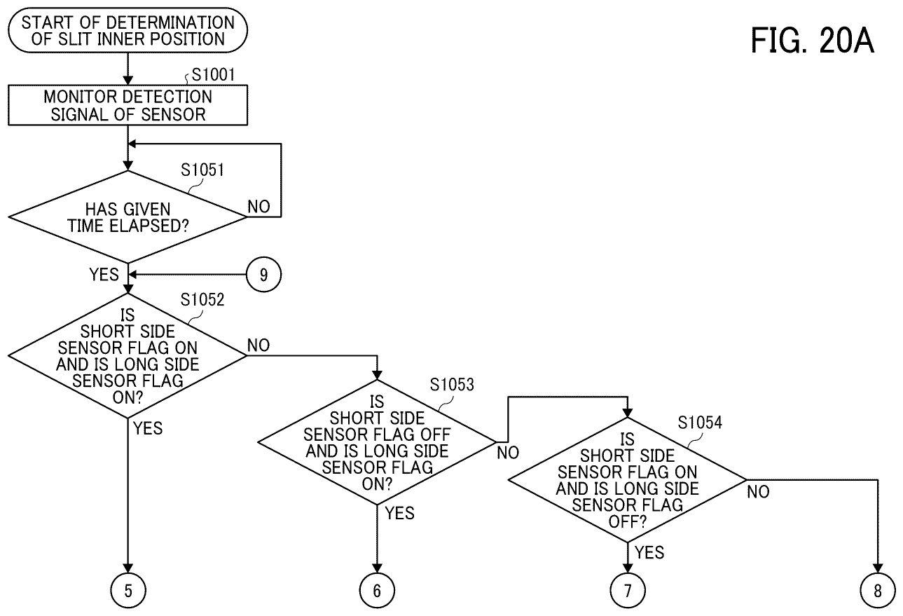

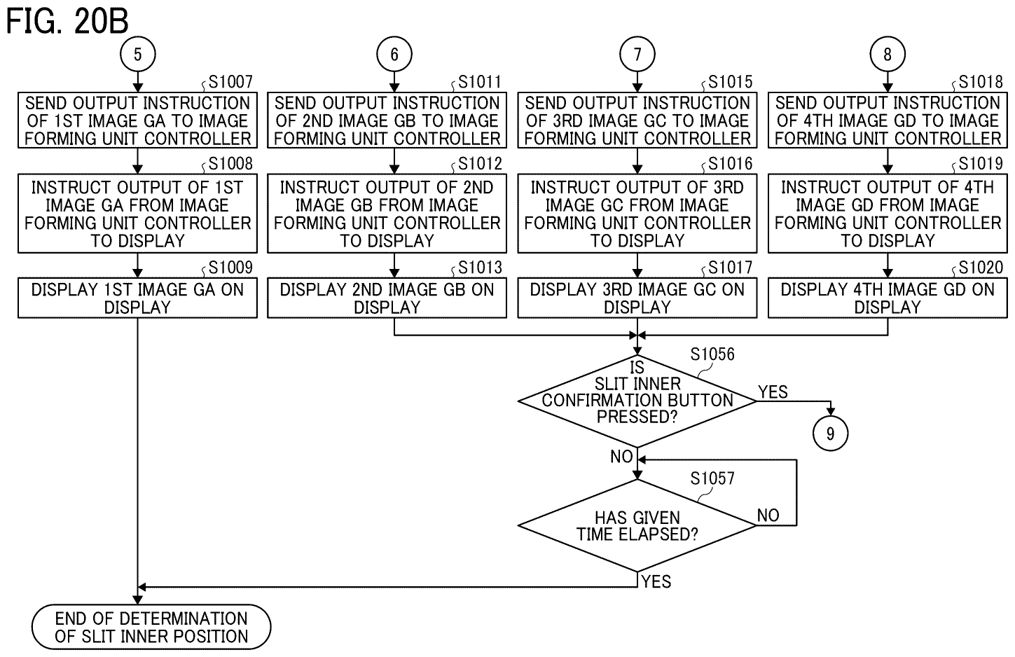

FIGS. 20A and 20B are the sections of a flowchart of a third modification of a process executable by the sheet binding unit 100.

In the process flow of the sheet binding unit 100 in the second example, when the position of the sheet bundle Sb is deviated, the CPU 110 always repeats the determination of the state of ON and OFF of the two sensor flags and the process of selecting an image to be output on the display 301. However, the process is not limited to the above-described process flow of the sheet binding unit 100. For example, in the process flow of the sheet binding unit 100 in the third modification illustrated in the flowchart of FIGS. 20A and 20B, the CPU 110 causes the display 301 to display the second image GB, the third image GC and the fourth image GD (steps S1013, S1017 and S1020), then the user corrects the position of the sheet bundle Sb while confirming the image on the display 301, and the slit interior check button 28 is pressed again (YES in step S1056). Only then, the CPU 110 repeats the determination (steps S1052, S1053 and S1054) and the process of selecting an image to be output on the display 301 (steps S1007 to S1009, S1011 to S1013, S1015 to S1017, and S1018 to S1020). As a result, the user can recognize the state of the sheet bundle Sb in the slit 23 after the correction of the position of the sheet bundle Sb.

In a case where the image displayed on the display 301 is any one of the second image GB, the third image GC and the fourth image GD, the user corrects the position of the sheet bundle Sb while confirming the image on the display 301, and (again) presses the slit interior check button 28 (YES in step S1056). Then, the CPU 110 repeats the determination (steps S1052, S1053 and S1054) and the process of selecting an image to be output on the display 301 (steps S1007 to S1009, S1011 to S1013, S1015 to S1017, and S1018 to S1020). On the other hand, when the first image GA indicating the state where the sheet bundle Sb is at the appropriate position (the sheet bundle Sb is at the executable position) is displayed (S1009), the CPU 110 can end the slit internal position determination process and perform the sheet binding operation to bind the sheet bundle Sb. Further, in a case where the slit interior check button 28 is not pressed again (NO in step S1056) after any one of the second image GB, the third image GC and the fourth image GD is displayed on the display 301 (S1013, S1017 and S1020), the CPU 110 ends the slit internal position determination process after the given time has elapsed (YES in step S1057).

### Process Flow in Sheet Binding Unit 100 (Second Example)

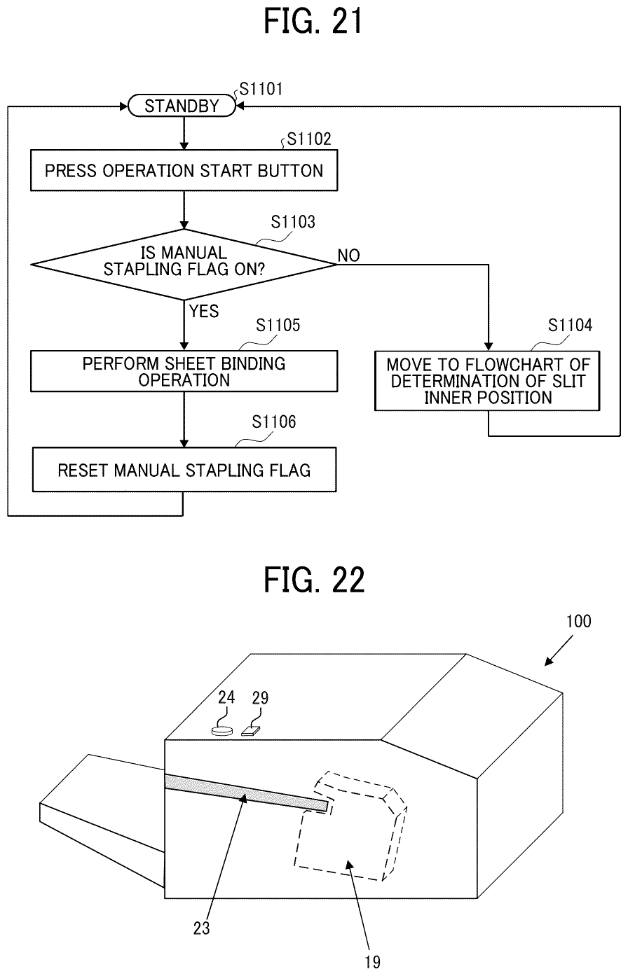

A description is now given of the second example of the flow of the process of a control processing program executed in the sheet binding unit 100, with reference to the flowchart of FIG. 21.

The flowchart of FIG. 21 is an example of the process in which the CPU 110 changes from the standby state to the slit internal position determination process when the slit interior check button 28 of the sheet binding unit 100 shares the function of the operation start button 24.

The CPU 110 in the standby state constantly monitors whether the operation start button 24 is pressed (step S1101). When the operation start button 24 is pressed in the standby state (YES in step S1102), the CPU 110 acquires information on whether the manual stapling flag is ON (or OFF) (step S1103). In the initial state, the manual stapling flag is OFF (NO in step S1103), and the CPU 110 changes to the slit internal position determination process (step S1104). In other words, even when the operation start button 24 is pressed (step S1102), if the manual stapling flag is OFF (NO in step S1103), the CPU 110 does not perform the sheet binding operation. When the slit internal position determination process is performed (step S1104), the CPU 110 returns to the standby state (step S1101), and the operation start button 24 is pressed (step S1102), the CPU 110 acquires information on whether the manual stapling flag is ON (or OFF) (step S1103) again.

The slit internal position determination process (S1104) is basically the same as the process flow of the first example described above. However, the process flow of the second example is different from the process flow of the first example in that a step of setting the manual stapling flag to ON is added. To be more specific, a step in which the CPU 110 changes the manual stapling flag from OFF to ON is added, in the process flow of the first example, after the first image GA is displayed, in other words, after step S1009 in the flowchart of FIG. 14B. As described above, when the first image GA is displayed, the sheet bundle Sb is at the executable position inside the slit 23. In other words, the sheet bundle Sb can receive the operation of manual stapling. After the step in which the manual stapling flag is changed from OFF to ON, the CPU 110 ends the slit internal position determination process, which is similar to the process flow of the first example described above.

After the step in which the manual stapling flag is changed from OFF to ON (when the sheet bundle Sb is at the executable position) and the slit internal position determination process (step S1104) is ended, the CPU 110 returns to the standby state (step S1101). When the operation start button 24 is pressed again (step S1102), the manual stapling flag is changed from OFF to ON (YES in step S1103).

When the manual stapling flag is ON (YES in step S1103), the CPU 110 performs the sheet binding operation in which the end portion of the sheet bundle Sb is bound is performed (step S1105). After the sheet binding operation is performed, the CPU 110 resets the manual stapling flag from ON to OFF (step S1106). After the manual stapling flag is reset, the CPU 110 returns to the standby state. On the other hand, after the slit internal position determination process ends while the manual stapling flag remains OFF (when the sheet bundle Sb is not at the executable position), the CPU 110 returns to the standby state (step S1101). When the operation start button 24 is pressed again (step S1102), the manual stapling flag is OFF (NO in step S1103), and the CPU 110 changes to the slit internal position determination process (step S1104).

### Second Embodiment of Sheet Binding Unit 100

A description is given below of a sheet binding unit according to a second embodiment of the present disclosure.

FIG. 22 is a diagram illustrating the sheet binding unit 100 according to the present embodiment.

The sheet binding unit 100 includes a light emitting diode (LED) emitter 29 (notification device) that indicates the position of the sheet bundle Sb inside the slit 23. The LED emitter 29 is mounted on a part of the exterior 25 of the sheet binding unit 100.

The LED emitter 29 is mounted in the vicinity of the operation start button 24. The hardware configuration of the sheet binding unit 100 according to the present embodiment is the same as the hardware configuration of the sheet binding unit 100 according to the first embodiment, except for the configuration in which the LED emitter 29 is connected to the CPU 110 via the I/F 111.

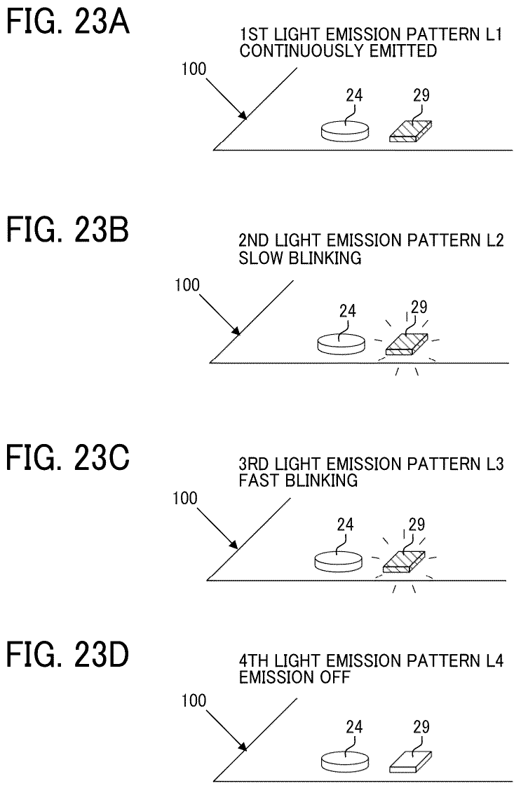

In the present embodiment, the CPU 110 selects the position information according to the determination result is the light emission pattern of the LED emitter 29. The CPU 110 varies the light emission of the LED emitter 29 as an example of a notification device. In the present embodiment, the LED emitter 29 by the control of the CPU 110 outputs four types of light emissions by the control of the CPU 110, as illustrated in FIGS. 23A, 23B, 23C and 23D. FIG. 23A illustrates the first light emission pattern L1 when both the short-side sensor flag and the long-side sensor flag are ON. The first light emission pattern L1 indicates a continuous light emission state in which the LED emitter 29 continuously emits light. The continuous light emission state represents the state in which the sheet bundle Sb has reached both the short-side contact position and the long-side contact position.

FIG. 23B illustrates the second light emission pattern L2 when the short-side sensor flag is OFF, and the long-side sensor flag is ON. The second light emission pattern L2 indicates a low-speed blinking state in which the LED emitter 29 repeats light-on and light-off at the low speed. The low-speed blinking state represents the state in which the sheet bundle Sb has not reached the short-side contact position but has reached the long-side contact position.

FIG. 23C illustrates the third light emission pattern L3 when the short-side sensor flag is ON, and the long-side sensor flag is OFF. The third light emission pattern L3 indicates a high-speed blinking state in which the LED emitter 29 repeats light-on and light-off at the high speed. The high-speed blinking state represents the state where the sheet bundle Sb has reached the short-side contact position but has not reached the long-side contact position. FIG. 23D illustrates the fourth light emission pattern L4 when both the short-side sensor flag and the long-side sensor flag are OFF. The fourth light emission pattern L4 indicates a light-off state in which the LED emitter 29 does not emit light. The light-off state represents the state where the sheet bundle Sb has not reached the short-side contact position and the long-side contact position.

### Process Flow in Sheet Binding Unit according to Second Embodiment (Third Example)

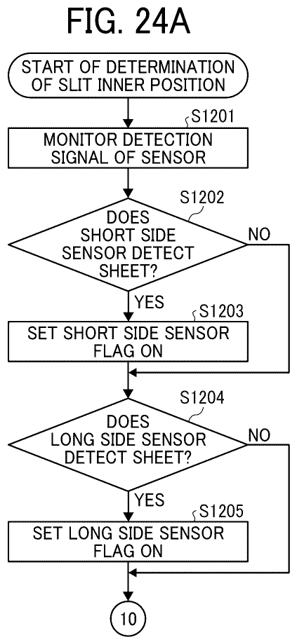

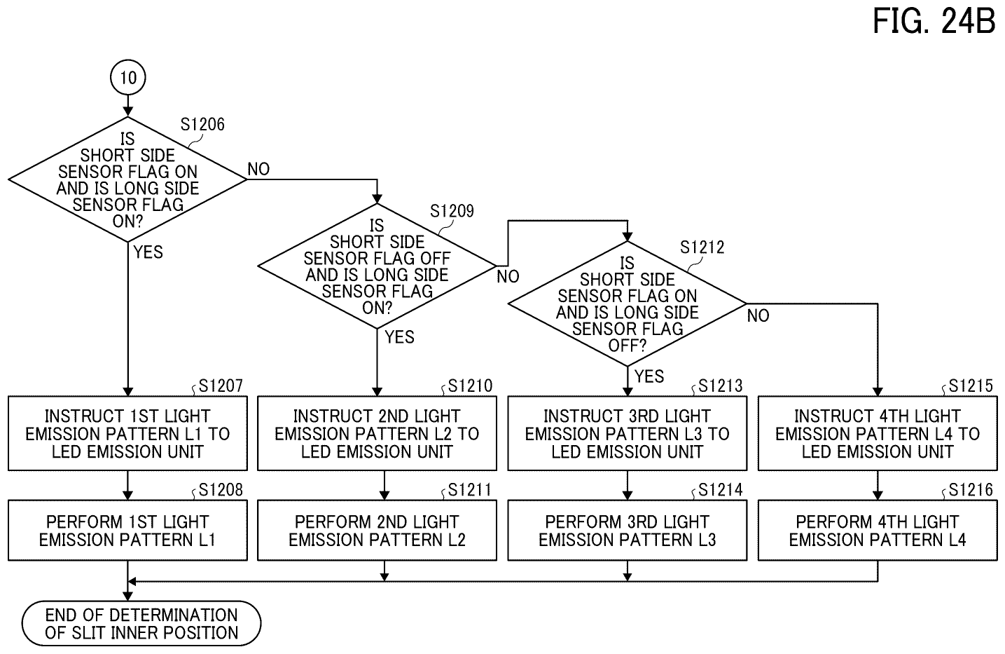

A description is now given of the third example of the flow of the process of a control processing program executed in the sheet binding unit 100 according to the present embodiment, with reference to the flowchart of FIGS. 24A and 24B.

FIGS. 24A and 24B are the sections of a flowchart of the third example of a process executable by the sheet binding unit 100.

The flowchart of FIGS. 24A and 24B is an example of the process in which the CPU 110 of the sheet binding unit 100 determines the position of the sheet bundle Sb inside the slit 23 and notifies the determination result (detection result) in the manual stapling operation.

The slit internal position determination process starts, for example, with the same process flow as the same process flow of the second example described above. In other words, when the manual stapling flag is ON after the pressing of the operation start button 24 (in step S1104 in the flowchart of FIG. 21), the CPU 110 starts the slit internal position determination process. The timing of the start of the slit internal position determination process is not limited to the above-described timing. For example, the slit interior check button 28 may be provided like the sheet binding unit 100 according to the first embodiment and the slit internal position determination process may be started at the timing at which the slit interior check button 28 is pressed. At the start of the slit internal position determination process, both the short-side sensor flag and the long-side sensor flag are OFF.

In step S1201, as the slit internal position determination process is started, the CPU 110 monitors the detection signals of the short-side sensor 27a and the long-side sensor 27b. In step S1202, the CPU 110 acquires information of whether there is a detection signal indicating that the short-side sensor 27a has detected the sheet S.

When there is a detection signal indicating that the short-side sensor 27a has detected the sheet S (YES in step S1202), the CPU 110 turns the short-side sensor flag to ON in step S1203. On the other hand, when there is no detection signal indicating that the short-side sensor 27a has detected the sheet S (NO in step S1202), the short-side sensor flag remains in OFF.

In step S1204, the CPU 110 acquires information of whether there is a detection signal indicating that the long-side sensor 27b has detected the sheet S. When there is a detection signal indicating that the long-side sensor 27b has detected the sheet S (YES in step S1204), the CPU 110 turns the long-side sensor flag to ON in step S1205. On the other hand, when there is no detection signal indicating that the long-side sensor 27b has detected the sheet S (NO in step S1204), the long-side sensor flag remains in OFF.

Then, the CPU 110 executes a process of selecting a light emission pattern of the LED emitter 29 based on the combination of ON and OFF of the two sensor flags, which are the short-side sensor flag and the long-side sensor flag. When both the short-side sensor flag and the long-long-side sensor flag are ON (YES in step S1206), the CPU 110 selects the above-described first light emission pattern L1 as a determination result, and sends the light emission instruction of the first light emission pattern L1 to the LED emitter 29 (step S1207). In step S1208, the LED emitter 29 that has received the instruction of light emission from the CPU 110 executes the first light emission pattern L1. As a result, the user can recognize that the sheet bundle Sb has reached the short-side contact position and the long-side contact position.

When the short-side sensor flag is OFF and the long-long-side sensor flag is ON (NO in step S1206 and YES in step S1209), the CPU 110 selects the above-described second light emission pattern L2 as a determination result, and sends the light emission instruction of the second light emission pattern L2 to the LED emitter 29 (step S1210). In step S1211, the LED emitter 29 that has received the instruction of light emission from the CPU 110 executes the second light emission pattern L2. As a result, the user can recognize that the sheet bundle Sb has not reached the short-side contact position but has reached the long-side contact position.

When the short-side sensor flag is ON and the long-side sensor flag is OFF (NO in step S1206, NO in step S1209, and YES in step S1212), the CPU 110 selects the above-described third light emission pattern L3 as a determination result, and sends the light emission instruction of the third light emission pattern L3 to the LED emitter 29 (step S1213). In step S1214, the LED emitter 29 that has received the instruction of light emission from the CPU 110 executes the third light emission pattern L3. As a result, the user can recognize that the sheet bundle Sb has reached the short-side contact position but has not reached the long-side contact position.

When both the short-side sensor flag and the long-long-side sensor flag are OFF (NO in steps S1206, S1209 and S1212), the CPU 110 selects the above-described fourth light emission pattern L4 as a determination result, and sends the light emission instruction of the fourth light emission pattern L4 to the LED emitter 29 (step S1215). In step S1216, the LED emitter 29 that has received the instruction of light emission from the CPU 110 executes the fourth light emission pattern L4. As a result, the user can recognize that the sheet bundle Sb has not reached the short-side contact position and the long-side contact position. After the LED emitter 29 has executed the first light emission pattern L1, the second light emission pattern L2, the third light emission pattern L3 and the fourth light emission pattern L4, the slit internal position determination process ends.

According to the present embodiment described above, the user recognizes the state of the sheet bundle Sb in the slit 23 from the light emission pattern of the LED emitter 29. Then, in a case where the sheet bundle Sb is at the executable position from the light emission pattern of the LED emitter 29, as the user presses the operation start button 24, the sheet binding operation in which the end portion of the sheet bundle Sb is bound is performed. Further, after the position of the sheet bundle Sb is corrected, the user can press the slit interior check button 28 again to recognize the state of the sheet bundle Sb inside the slit 23.

In a case where the CPU 110 performs the slit internal position determination process, the light emission patterns that are performed by the LED emitter 29 are not limited to the first light emission pattern L1, the second light emission pattern L2, the third light emission pattern L3 and the fourth light emission pattern L4 illustrated in FIGS. 23A, 23B, 23C and 23D, respectively. For example, the light emission pattern that the CPU 110 causes the LED emitter 29 to execute may be a pattern in which the light emission color of the LED is varied. Then, similar to the above-described example, the user can recognize the state of the sheet bundle Sb in the slit 23. In this example, the LED emitter 29 includes, for example, a multicolor LED that can emit light in three or more colors. The contents of the slit internal position determination process performed by the CPU 110 are the same as the above-described process flow, except that the light emission patterns are different. Further, the states of the sheet bundle Sb inside the slit 23 indicated by the first light emission pattern L1, the second light emission pattern L2, the third light emission pattern L3 and the fourth light emission pattern L4 are the same as the states indicated by the first light emission pattern L1, the second light emission pattern L, the third light emission pattern L3 and the fourth light emission pattern L4 illustrated in FIGS. 23A, 23B, 23C and 23D described above.

For example, the LED emitter 29 that has received the instruction of the first light emission pattern L1, the second light emission pattern L2, the third light emission pattern L3 and the fourth light emission pattern L4 emits light in the emission colors of “blue”, “green”, “yellow” and “red”, respectively. The user can recognize the state of the sheet bundle Sb in the slit 23 from the emission color of the LED emitter 29.

### Third Embodiment of Sheet Binding Unit 100

A description is given below of a sheet binding unit according to a third embodiment of the present disclosure.

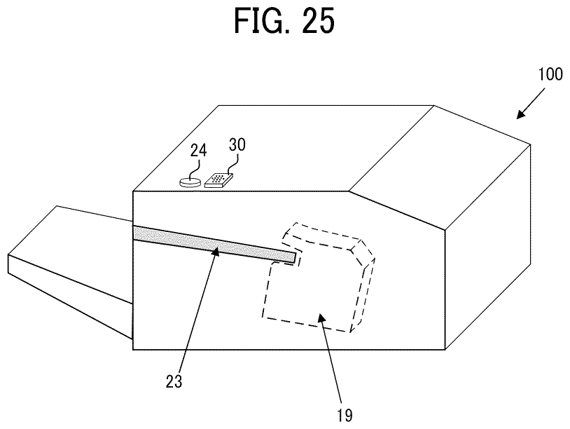

FIG. 25 is an external view of the sheet binding unit 100 according to the present embodiment.

The sheet binding unit 100 includes a sound output mechanism 30 (notification device) that outputs a notification to notify the position of the sheet bundle Sb inside the slit 23. The sound output mechanism 30 is, for example, a speaker. The sound output mechanism 30 is mounted on a part of the exterior 25 of the sheet binding unit 100. The sound output mechanism 30 is disposed in the vicinity of the operation start button 24.

The hardware configuration of the sheet binding unit 100 according to the present embodiment is the same as the hardware configuration of the sheet binding unit 100 according to the first embodiment, except for the configuration in which the sound output mechanism 30 is connected to the CPU 110 via the I/F 111.

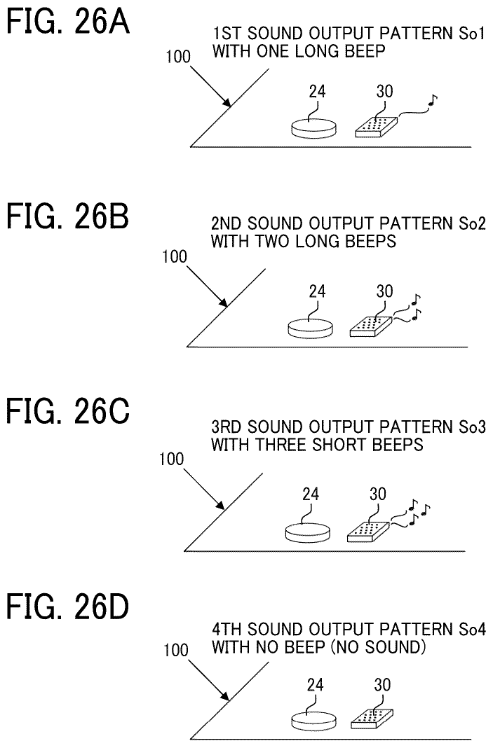

In the present embodiment, the position information to be selected by the CPU 110 according to the determination result (detection result) is an output of sound by the sound output mechanism 30. The CPU 110 causes the sound output mechanism 30 to execute the sound output pattern, as an example of the notification device. The sound output mechanism 30 can change the sound output pattern by the control of the CPU 110. In the present embodiment, the sound output mechanism 30 outputs four types of sound output patterns by the control of the CPU 110, as illustrated in FIGS. 26A, 26B, 26C and 26D.

FIG. 26A illustrates a first sound output pattern So1 when both the short-side sensor flag and the long-side sensor flag are ON. The first sound output pattern So1 indicates a long sound output state where the sound output mechanism 30 outputs a long sound such as a long beep (prolonged sound). The long sound output state represents the state in which the sheet bundle Sb has reached both the short-side contact position and the long-side contact position.

FIG. 26B illustrates the second sound output pattern So2 when the short-side sensor flag is OFF, and the long-side sensor flag is ON. The second sound output pattern So2 indicates a short sound output state where the sound output mechanism 30 outputs a short sound such as a short beep (shortened sound) that is shorter than the first sound output pattern So1. The short sound output state represents the state in which the sheet bundle Sb has not reached the short-side contact position but has reached the long-side contact position.

FIG. 26C illustrates the third sound output pattern So3 when the short-side sensor flag is ON, and the long-side sensor flag is OFF. The third sound output pattern So3 indicates a short sound continuous output state where the sound output mechanism 30 constantly outputs short sounds such as short beeps (shortened sounds) that are shorter than the second sound output pattern So2. The short sound continuous output state represents the state where the sheet bundle Sb has reached the short-side contact position but has not reached the long-side contact position.

FIG. 26D illustrates a fourth sound output pattern So4 when both the short-side sensor flag and the long-side sensor flag are OFF. The fourth sound output pattern So4 indicates no sound state where the sound output mechanism 30 outputs no sound. The no sound state represents the state where the sheet bundle Sb has not reached the short-side contact position and the long-side contact position.

The flow of the process of the control processing program to be executed in the sheet binding unit 100 according to the present embodiment is basically the same as the flow of the process of the third example described above, except that, in the present embodiment, the CPU 110 sends instruction to the sound output mechanism 30 instead of the LED emitter 29 and the sound output mechanism 30 that has received the instruction from the CPU 110 executes the sound output pattern.

More specifically, the above-described process flows of the third example share the same process from the start of the slit inner position determination to the switching between ON and OFF of the short-side sensor flag and the long-side sensor flag according to the detection signals of the short-side sensor 27a and the long-side sensor 27b, in other words, the process from steps S1201 to S1205 in the flowchart of FIGS. 24A and 24B. In the subsequent process, the CPU 110 selects one of the first sound output pattern So1, the second output pattern So2, the third sound output pattern So3 and the fourth sound output pattern So4 of the sound output mechanism 30 depending on the combination of ON and OFF of the two sensor flags. Then, the CPU 110 sends the instruction of the selected one of the first sound output pattern So1, the second output pattern So2, the third sound output pattern So3 and the fourth sound output pattern So4 to the sound output mechanism 30. The sound output mechanism 30 that has received the instruction from the CPU 110 executes any one of the first sound output pattern So1, the second output pattern So2, the third sound output pattern So3 and the fourth sound output pattern So4. After the sound output mechanism 30 has executed the first sound output pattern So1, the second output pattern So2, the third sound output pattern So3 and the fourth sound output pattern So4, the slit internal position determination process ends.

According to the present embodiment described above, the user recognizes the state of the sheet bundle Sb in the slit 23, from the sound output pattern of the sound output mechanism 30. Then, in a case where it is recognized that the sheet bundle Sb is at the executable position from the sound output pattern of the sound output mechanism 30, as the user presses the operation start button 24, the sheet binding operation in which the end portion of the sheet bundle Sb is bound is performed. Further, after the position of the sheet bundle Sb is corrected, the user can press the slit interior check button 28 again to recognize the state of the sheet bundle Sb inside the slit 23.

In a case where the CPU 110 performs the slit internal position determination process, the sound output pattern that is performed by the sound output mechanism 30 is not limited to the first sound output pattern So1, the second sound output pattern So2, the third sound output pattern So3 and the fourth sound output pattern So4 illustrated in FIGS. 26A, 26B, 26C and 26D, respectively. The sound output pattern that the CPU 110 causes the sound output mechanism 30 to perform may be a pattern in which the state of the sheet bundle Sb in the slit 23 is indicated by sound. In this example, the sound output mechanism 30 selects and outputs one of multiple sounds stored in advance in the memory, for example. The contents of the slit internal position determination process performed by the CPU 110 are the same as the above-described process flow, except that the sound output patterns are different. Further, the states of the sheet bundle Sb inside the slit 23 indicated by the first sound output pattern So1, the second sound output pattern So2, the third sound output pattern So3 and the fourth sound output pattern So4 are the same as the states indicated by the first sound output pattern So1, the second sound output pattern So2, the third sound output pattern So3 and the fourth sound output pattern So4 illustrated in FIGS. 26A, 26B, 26C and 26D described above.

For example, the sound output mechanism 30 that has received the instruction of the first sound output pattern So1, the second sound output pattern So2, the third sound output pattern So3 and the fourth sound output pattern So4 outputs the sounds such as “sheet binding operation available”, “sheet bundle not reached in conveyance direction”, “sheet bundle not reached in width direction”, and “sheet bundle not reached in conveyance and width directions”, respectively. The user can recognize the state of the sheet bundle Sb in the slit 23, from the sound of the sound output mechanism 30.

### Fourth Embodiment of Sheet Binding Unit 100

A description is given below of a sheet binding unit according to a fourth embodiment of the present disclosure.

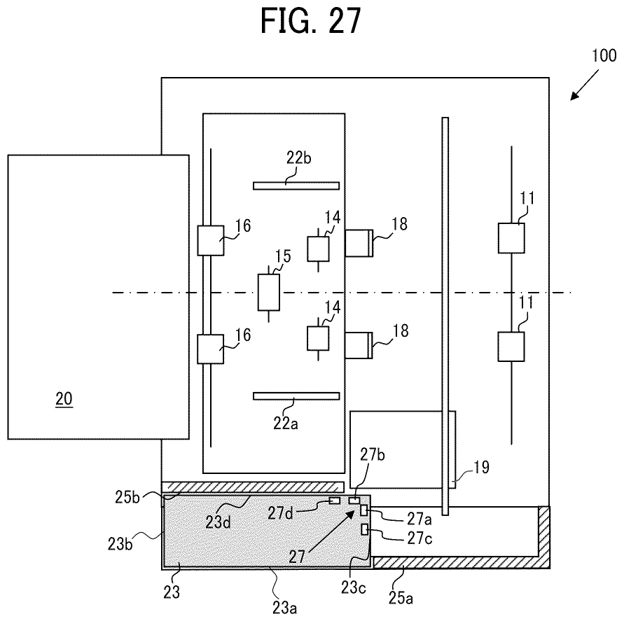

FIG. 27 is a plan view of the sheet binding unit 100 according to the present embodiment.

The sheet binding unit 100 according to the present embodiment has the same configuration as the sheet binding unit 100 according to the first embodiment, except that the sheet binding unit 100 according to the present embodiment further includes a sheet bundle detection sensor group 27.

The sheet bundle detection sensor group 27 further includes a short-side extension sensor 27c and a long-side extension sensor 27d in addition to the short-side sensor 27a and the long-side sensor 27b. The short-side extension sensor 27c and the long-side extension sensor 27d are disposed in the slit 23. The short-side extension sensor 27c is disposed on the near side (front side) in the width direction (on the opposite side of the width direction stopper 25b) at a given interval to the short-side sensor 27a in the width direction. The long-side extension sensor 27d is disposed on the root end side in the conveyance direction (on the on the opposite side of the conveyance direction stopper 25a) at a given interval to the long-side sensor 27b. Similarly to FIG. 13A, the relative positions of the executable position P of the stapling unit 19 and each of the short-side sensor 27a and the long-side sensor 27b disposed facing each other. However, the relative positions are not limited to the above-described relative positions. For example, the relative positions of the long-side sensor 27b and the executable position P may be the same as the relative positions in FIG. 13A, and the short-side sensor 27a and the short-side extension sensor 27c may be disposed facing the executable position P. Alternatively, the long-side extension sensor 27d and the executable position P may be disposed facing each other, and the short-side sensor 27a and the short-side extension sensor 27c may be disposed facing the executable position P.

FIG. 27 illustrates the configuration of the stapling unit 19 but may be applied to the configuration of the crimp binding unit 26.

At this time, the relative positions of the executable position P of the crimp binding unit 26 and each of the short-side sensor 27a, the long-side sensor 27b, the short-side extension sensor 27c and the long-side extension sensor 27d may be applied to each structure of the present embodiment.

As described above, the short-side sensor 27a and the long-side sensor 27b detect that the sheet bundle Sb has reached the short-side contact position and the long-side contact position, respectively. Then, the detection signal of the short-side sensor 27a and the long-side sensor 27b and the detection signal of the short-side extension sensor 27c and the long-side extension sensor 27d are combined. By so doing, the CPU 110 can determine the more detailed state of the position of the sheet bundle Sb in the slit 23.

Similarly to the first embodiment, when determining the position information of the sheet bundle Sb, the CPU 110 changes the short-side sensor flag to ON based on the detection signal of the short-side sensor 27a and the long-side sensor flag to ON based on the detection signal of the long-side sensor 27b. Further, the CPU 110 changes the short-side extension sensor flag to ON based on the detection signal of the short-side extension sensor 27c and the long-side extension sensor flag to ON based on the detection signal of the long-side extension sensor 27d.

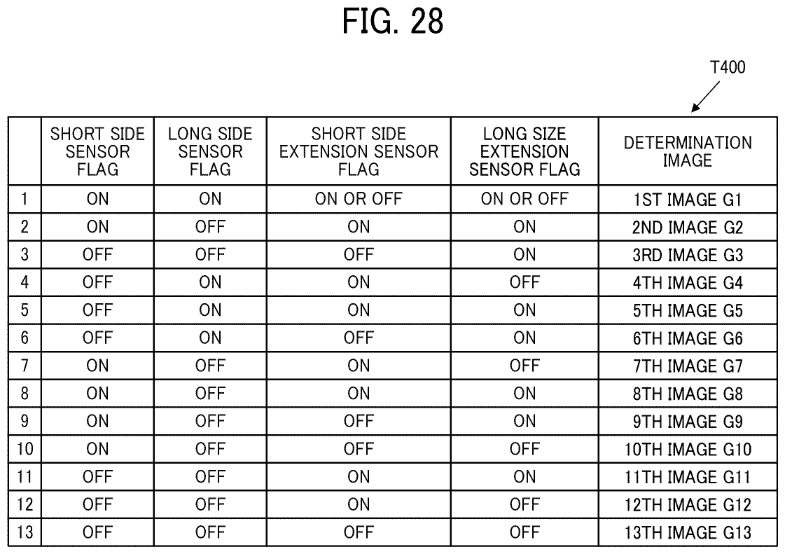

In the present embodiment, the position information to be selected by the CPU 110 according to the determination result (detection result) is an image displayed on the display 301. Then, the CPU 110 selects and determines an image as the position information to be selected according to the combination of ON and OFF of the four sensor flags, from three or more selections. In the present embodiment, for example, the CPU 110 determines according to the determination table illustrated in FIG. 28.

As illustrated in the determination table T400 illustrated in FIG. 28, there are 13 combinations of ON and OFF of the four sensor flags. As a result, the images to be selected or generated by the CPU 110 as the determination result are 13 patterns. Although there are actually four combinations of the short-side sensor flag and the long-side sensor flag both being ON, the determination table T400 indicates that the sheet is at the executable position when both the short-side sensor flag and the long-side sensor flag are ON, and the combinations are grouped into one pattern regardless of ON and OFF of the short-side extension sensor flag and the long-side extension sensor flag. There are 12 patterns of combinations other than the combination in which both the short-side sensor flag and the long-side sensor flag are ON.

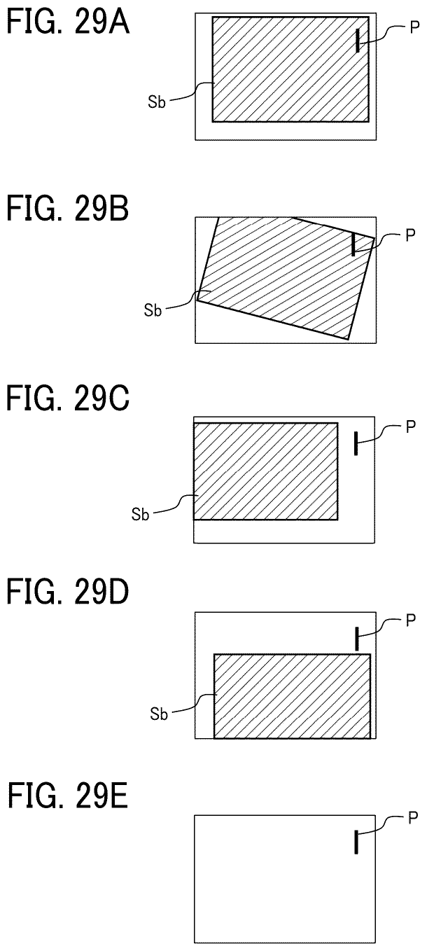

FIGS. 29A, 29B, 29C, 29D and 29E are diagrams illustrating examples of images to be selected or generated as a determination result by the CPU 110 in the present embodiment.

Further, in FIGS. 29A, 29B, 29C, 29D and 29E, the executable position P at which the sheet binding operation can be performed on the sheet bundle Sb is displayed in a superimposed manner. As a result, the user can recognize the state of the sheet bundle Sb inside the slit 23 more easily.

FIG. 29A illustrates a first image G1 when both the short-side sensor flag and the long-side sensor flag are ON.

The first image G1 illustrates the state where the sheet bundle Sb has reached both the short-side contact position and the long-side contact position. FIG. 29A also indicates that the executable position P is at a position overlapping the sheet bundle Sb in both the conveyance direction and the width direction.

FIG. 29B illustrates a second image G2 when the short-side sensor flag is ON, the long-side sensor flag is OFF, the short-side extension sensor flag is ON, and the long-side extension sensor flag is ON. The second image G2 illustrates the state where the sheet bundle Sb has reached the short-side sensor 27a, the short-side extension sensor 27c and the long-side extension sensor 27d of the four sensors 27a to 27d. However, the sheet bundle Sb has not reached only the long-side sensor 27b, and the sheet bundle Sb is inclined with respect to the slit 23.

FIG. 29C illustrates a third image G3 when the short-side sensor flag is OFF, the long-side sensor flag is OFF, the short-side extension sensor flag is OFF, and the long-side extension sensor flag is ON. The third image G3 illustrates the state where the sheet bundle Sb has reached the long-side extension sensor 27d only of the four sensors 27a to 27d. FIG. 29D illustrates a twelfth image G12 when the short-side sensor flag is OFF, the long-side sensor flag is OFF, the short-side extension sensor flag is ON, and the long-side extension sensor flag is OFF. The twelfth image G12 illustrates the state where the sheet bundle Sb has reached the short-side extension sensor 27c only of the four sensors 27a to 27d. The description of a fourth image G4 to an eleventh image G11 is omitted in FIGS. 29A, 29B, 29C, 29D and 29E.

FIG. 29E illustrates a thirteenth image G13 when all the four sensor flags are OFF. The thirteenth image G13 illustrates the state where the sheet bundle Sb has not reached all the four sensors 27a to 27d. Further, FIG. 29E indicates that the sheet bundle Sb and the executable position P are at a position not overlapping in both the conveyance direction and the width direction.

### Process Flow in Sheet Binding Unit 100 (Fourth Example)

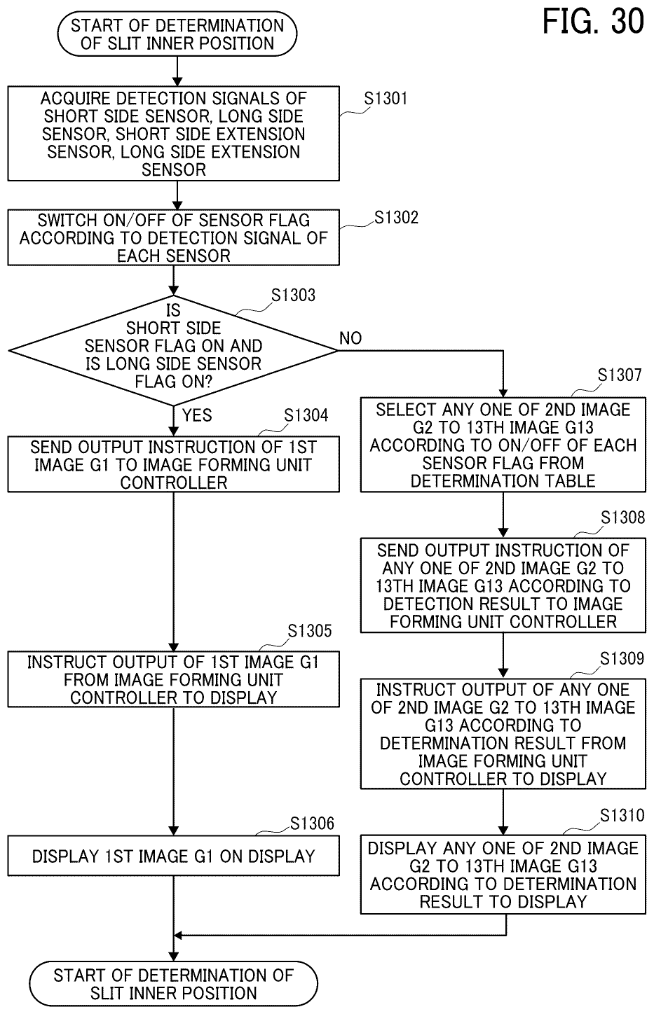

A description is now given of the fourth example of the process flow of a control processing program executed in the sheet binding unit 100, with reference to the flowchart of FIG. 30.

The flowchart of FIG. 30 is an example of the process in which the CPU 110 of the sheet binding unit 100 determines the position of the sheet bundle Sb inside the slit 23 and outputs a notification of the determination result in the manual stapling operation.

The slit internal position determination process starts, for example, with the same process flow as the same process flow of the second example and the third example described above. The timing of the start of the slit internal position determination process is not limited to the above-described timing. For example, the slit interior check button 28 may be provided like the sheet binding unit 100 according to the first embodiment and the slit internal position determination process may be started at the timing at which the slit interior check button 28 is pressed. At the start of the slit internal position determination process, the short-side sensor flag, the long-side sensor flag, the short-side extension sensor flag and the long-side extension sensor flag are all OFF.

As the slit internal position determination process is started, the CPU 110 acquires the detection signal of the short-short-side sensor 27a, the long-side sensor 27b, short-side extension sensor 27c and the long-side extension sensor 27d (step S1301).

Then, in step S1302, the CPU 110 changes ON and OFF of the short-side sensor flag, the long-side sensor flag, the short-side extension sensor flag and the long-side extension sensor flag according to whether there is a detection signal of the short-side sensor 27a, the long-side sensor 27b, the short-side extension sensor 27c and the long-side extension sensor 27d.

Then, the CPU 110 selects an image to be output to the display 301 based on the determination table T400, according to the combination of ON and OFF of the four sensor flags. In step S1303, the CPU 110 determines whether both the short-side sensor flag and the long-side sensor flag are ON. When both the short-side sensor flag and the long-side sensor flag are ON (YES in step S1303), the CPU 110 selects the position information of the first image G1 as a determination result, and sends the output instruction of the first image G1 to the image forming device controller 306 (step S1304). In step S1305, the image forming device controller 306 that has received the instruction from the CPU 110 transmits an instruction to output the first image G1 to the display 301. In step S1306, the display 301 that has received the output instruction from the image forming device controller 306 displays the first image G1. As a result, the user can recognize that the sheet bundle Sb has reached the short-side contact position and the long-side contact position. In other words, the user can recognize that the sheet bundle Sb is at the executable position where the sheet binding operation can be performed on the sheet bundle Sb inside the slit 23.

When the short-side sensor flag and the long-side sensor flag are not ON (NO in step S1303), the CPU 110 selects any one of the second image G2 to the thirteenth image G13 according to ON and OFF of each sensor flag from the determination table T400 (step S1307), and sends the output instruction of the second image G2 to the thirteenth image G13 to the image forming device controller 306 (step S1308). In step S1309, the image forming device controller 306 that has received the output instruction from the CPU 110 sends an instruction to output any one of the second image G2 to the thirteenth image G13 according to the determination result, to the display 301. In step S1310, the display 301 that has received the output instruction from the image forming device controller 306 displays any one of the second image G2 to the thirteenth image G13 according to the determination result. As a result, the user can recognize the state of the sheet bundle Sb in the slit 23 from the image displayed on the display 301. After any one of the first image G1 to the thirteenth image G13 is displayed, the CPU 110 ends the slit internal position determination process.

According to the present embodiment described above, the state of the sheet bundle Sb inside the slit 23 can be recognized from the image displayed on the display 301. Then, in a case where the sheet bundle Sb is at the executable position at which the sheet binding operation can be performed, from the first image G1 displayed on the display 301, as the user presses the operation start button 24, the sheet binding operation in which the end portion of the sheet bundle Sb is bound is performed. On the other hand, in a case where the sheet bundle Sb is not at the executable position from any one of the second image G2 to the thirteenth image G13 displayed on the display 301, the user can modify the position of the sheet bundle Sb. The CPU 110 can determine the detailed state of the position of the sheet bundle Sb in the slit 23, from the determination result based on the determination result of the four sensors 27a to 27d.

In the sheet binding unit 100 according to the present embodiment, the determination result selected by the CPU 110 as the position information and notified to the user is not limited to the image displayed on the display 301. For example, the determination result may be the light emission pattern of the LED emitter 29 as the above-described second embodiment or may be the sound output pattern of the sound output mechanism 30 as the above-described third embodiment.

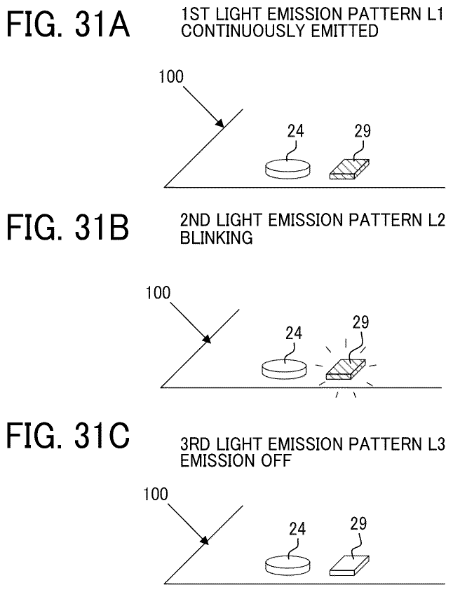

FIGS. 31A, 31B and 31C are diagrams illustrating examples of light emission patterns of the LED emitter 29 by the control of the CPU 110.

The configuration of the LED emitter 29 is the same as the configuration of the LED emitter 29 according to the above-described second embodiment. In the present embodiment, the LED emitter 29 by the control of the CPU 110 has three types of light emission patterns.

FIG. 31A illustrates the first light emission pattern L1 when both the short-side sensor flag and the long-side sensor flag are ON. The first light emission pattern L1 indicates a continuous light emission state in which the LED emitter 29 continuously emits light. The continuous light emission state represents the state in which the sheet bundle Sb has reached both the short-side contact position and the long-side contact position.

FIG. 31B illustrates the second light emission pattern L2 when at least one of the four sensor flags is ON (except that both the short-side sensor flag and the long-side sensor flag are ON). The second light emission pattern L2 indicates a blinking state where the LED emitter 29 repeats light-on and light-off. This blinking state represents the state in which the sheet bundle Sb has reached at least one of the four sensors 27a to 27d (except that the sheet bundle Sb has reached both the short-side contact position and the long-side contact position).

FIG. 31C illustrates the third light emission pattern L3 when all the sensor flags are OFF. The third light emission pattern L3 indicates a light-off state in which the LED emitter 29 does not emit light. The light-off state represents the state where the sheet bundle Sb has not reached all the four sensors 27a to 27d. As a result, the user can recognize the state of the sheet bundle Sb in the slit 23 from the light emission pattern of the LED emitter 29.

The flow of the process of the control processing program to be executed in the sheet binding unit 100 according to the present embodiment is basically the same as the flow of the process of the fourth example described above, except that, in the present embodiment, the CPU 110 sends instruction to the LED emitter 29 instead of that the CPU 110 sends the instruction to the display 301 via the image forming device controller 306, and the LED emitter 29 that has received the instruction from the CPU 110 executes the light emission pattern.

In a case where the CPU 110 performs the slit internal position determination process, the light emission pattern that is performed by the LED emitter 29 is not limited to the first light emission pattern L1, the second light emission pattern L2, and the third light emission pattern L3 illustrated in FIGS. 31A, 31B and 31C, respectively. For example, the light emission pattern that the CPU 110 causes the LED emitter 29 to execute may be a pattern in which the light emission color of the LED is varied. Then, similar to the above-described example, the user can recognize the state of the sheet bundle Sb in the slit 23. In this example, the LED emitter 29 includes, for example, a multicolor LED that can emit light in three or more colors. The contents of the slit internal position determination process performed by the CPU 110 are the same as the above-described process flow, except that the light emission patterns are different. Further, the states of the sheet bundle Sb inside the slit 23 indicated by the first light emission pattern L1, the second light emission pattern L2 and the third light emission pattern L3 are the same as the states indicated by the first light emission pattern L1, the second light emission pattern L2 and the third light emission pattern L3 illustrated in FIGS. 31A, 31B and 31C described above. For example, the LED emitter 29 that has received the instruction of the first light emission pattern L1, the second light emission pattern L2 and the third light emission pattern L3 emits light in the light emitting colors of “blue”, “green”, and “red”, respectively. The user can recognize the state of the sheet bundle Sb in the slit 23 from the emission color of the LED emitter 29.

Further, for example, the light emission pattern that the CPU 110 causes the LED emitter 29 to execute may be a light emission pattern that varies so as to approach one color from another color in a stepwise manner. Then, similar to the above-described example, the user can recognize the state of the sheet bundle Sb in the slit 23. In this example, the LED emitter 29 includes, for example, a multicolor LED that can emit light in two or more colors and control each light amount separately.

For example, the LED emitter 29 that has received the instruction of the first light emission pattern L1, the second light emission pattern L2 and the third light emission pattern L3 emits light in the emission colors of “blue”, “neutral color between blue and red”, and “red”, respectively. The user can recognize the state of the sheet bundle Sb in the slit 23 from the emission color of the LED emitter 29. Further, in this example, when the LED emitter 29 emits light in the “neutral color between blue and red” of the second light emission pattern L2, the emission color is varied in a stepwise manner, so that the light amount of blue is increased and the light amount of red is decreased as the sheet bundle Sb approaches the executable position. In other words, as the sheet bundle Sb moves away from the executable position, the LED emitter 29 varies the emission color in a stepwise manner so as to decrease the light amount of blue and increase the light amount of red.

For example, the CPU 110 determines that the sheet bundle Sb is closer to the executable position as the number of sensor flags in the ON state increases, and determines that the sheet bundle Sb is farther from the executable position as the number of sensor flags in the ON state decreases. The user can recognize the more detailed state (position) of the sheet bundle Sb in the slit 23 from the emission color of the LED emitter 29 that varies in the stepwise manner.

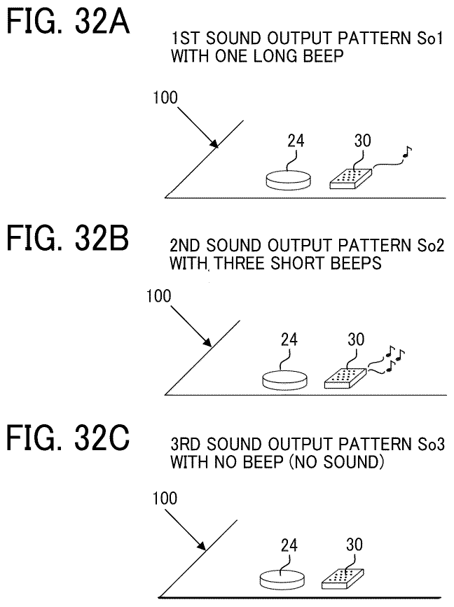

FIGS. 32A, 32B and 32C are diagrams illustrating examples of sound output patterns of the sound output mechanism 30 by the control of the CPU 110.

The configuration of the sound output mechanism 30 is the same as the configuration of the sound output mechanism 30 according to the third embodiment. In the present embodiment, there are three types of sound output patterns of the sound output mechanism 30 by the control of the CPU 110.

FIG. 32A illustrates the first sound output pattern So1 when both the short-side sensor flag and the long-side sensor flag are ON. The first sound output pattern So1 indicates a long sound output state where the sound output mechanism 30 outputs a long sound such as a long beep (prolonged sound). The long sound output state represents the state in which the sheet bundle Sb has reached both the short-side contact position and the long-side contact position.

FIG. 32B illustrates the second sound output pattern So2 when at least one of the four sensor flags is ON (except that both the short-side sensor flag and the long-side sensor flag are ON). The second sound output pattern So2 indicates a short sound output state where the sound output mechanism 30 continuously outputs, for example, a short sound such as a short beep (shortened sound). This short sound continuous output state represents the state in which the sheet bundle Sb has reached at least one of the four sensors 27a to 27d (except that the sheet bundle Sb has reached both the short-side contact position and the long-side contact position).

FIG. 32C illustrates the third sound output pattern So3 when all the four sensor flags are OFF. The third sound output pattern So3 indicates no sound state where the sound output mechanism 30 outputs no sound. The no sound state represents the state where the sheet bundle Sb has not reached all the four sensors 27a to 27d.

The flow of the process of the control processing program to be executed in the sheet binding unit 100 according to the present embodiment is basically the same as the flow of the process of the fourth example described above, except that, in the present embodiment, the CPU 110 sends instruction to the sound output mechanism 30 instead of that the CPU 110 sends the instruction to the display 301 via the image forming device controller 306, and the sound output mechanism 30 that has received the instruction from the CPU 110 executes the sound output pattern.

Further, for example, the sound output pattern that the CPU 110 causes the sound output mechanism 30 to execute may be a sound output pattern that varies so as to approach no sound state from the long sound output state in a stepwise manner. Then, similar to the above-described example, the user can recognize the state of the sheet bundle Sb in the slit 23. In this example, the sound output mechanism 30 can perform control to vary the interval of the sound in a stepwise manner, for example.

For example, the LED emitter 29 that has received the light emission instruction of the first sound output pattern So1, the second sound output pattern So2 and the third sound output pattern So3 outputs the “long sound output state”, the “short sound output state” and the “no sound state”, respectively. The user can recognize the state of the sheet bundle Sb in the slit 23, from the length of sound of the sound output mechanism 30. Further, in this example, when the sound output mechanism 30 outputs sound in the “short sound output state” of the second light emission pattern L2, the sound output is varied in the stepwise manner to decrease the interval of the lengths of sounds as the sheet bundle Sb approaches the executable position. In other words, as the sheet bundle Sb moves away from the executable position, the sound output mechanism 30 varies the sound output in a stepwise manner so as to increase the interval of the lengths of sound.

For example, the CPU 110 determines that the sheet bundle Sb is closer to the executable position as the number of sensor flags in the ON state increases, and determines that the sheet bundle Sb is farther from the executable position as the number of sensor flags in the ON state decreases. The user can recognize the more detailed state of the sheet bundle Sb in the slit 23 from the sound output of the sound output mechanism 30 that varies in the stepwise manner.

In the present embodiment, the sheet bundle detection sensor group 27 includes four sensors 27a to 27d, but the present disclosure is not limited to this configuration. For example, the sheet bundle detection sensor group 27 may include a greater number of sensors. The number of image patterns, light emission patterns, or sound output patterns as the determination result may be increased according to the number of sensors. As a result, the user can recognize the more detailed state of the sheet bundle Sb in the slit 23.

### Modification of Image Forming System

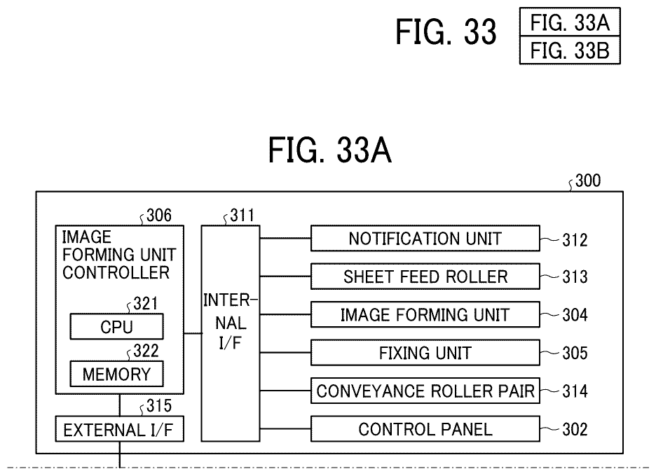

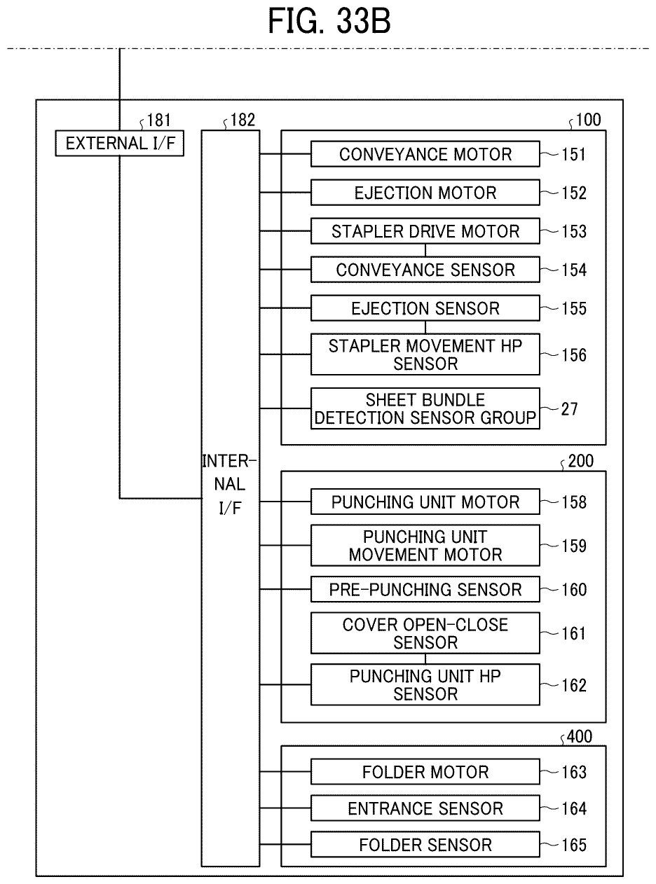

FIGS. 33A and 33B of FIG. 33 are the parts of a block diagram of a hardware configuration of an image forming system according to a modification of the present disclosure.

In each of the above-described embodiments, the configuration in which the CPU 110 of the sheet binding unit 100 executes the determination as a determination unit, but the present disclosure is not limited the above-described configuration. In the image forming system according to the present modification, the image forming device controller 306 of the image forming device 300 (image forming apparatus) executes the determination as the determination unit. The same components of the above-described embodiments are denoted by the same reference numerals, and the description of the modification is omitted.

The image forming device controller 306 illustrated in FIG. 33A controls the operations of the components of the image forming device 300 (for example, a notification unit 312, a sheet feed roller 313, an image forming unit 304, the fixing device 305, the conveyance roller pair 314, and the control panel 302) via an internal interface (I/F) 311 and the operations of drive sources of the sheet binding unit 100 (for example, the sheet conveyance motor 151, the sheet ejection motor 152, and the stapler drive motor 153) and various sensors (for example, the sheet conveyance sensor 154, the sheet ejection sensor 155, the stapler HP sensor 156, and the sheet bundle detection sensor group 27) via external interfaces (I/Fs) 315 and 181 and an internal interface (I/F) 182. In other words, the sheet binding unit 100 operations under the control of the image forming device controller 306 included in the image forming device 300.

The image forming device 300 may be an inkjet system that forms an image using ink or an electrophotographic system that forms an image using toner as long as the image forming device 300 forms an image on a sheet S similarly to the above-described embodiments. The sheet feed roller 313 feeds the sheets S stored in the sheet feeding device 303 toward the image forming unit 304 one by one. Similarly to the above-described embodiments, the image forming unit 304 transfers the image on the sheet S fed by the sheet feed roller 313, and the fixing device 305 fixes the image transferred on the sheet S. The conveyance roller pair 314 conveys the sheet S that has passed the fixing device 305 toward the sheet binding unit 100.

The image forming device controller 306 includes, for example, a central processing unit (CPU) 321 and a memory 322. The memory 322 includes, for example, a read only memory (ROM), a random access memory (RAM), a hard disk drive (HDD), or a combination of the ROM, the RAM and the HDD. The memory 322 stores each image to be displayed based on the determination result (notification result) of each of the above-described embodiments. The image forming device controller 306 controls operations of each drive source and various sensors of the punching unit 200 and each drive source and various sensors of the sheet folding unit 400, via the external interfaces (I/Fs) 315 and 181 and the internal interface (I/F) 182.

In the present modification, the detection signal of the sheet bundle detection sensor group 27 is input to the image forming device controller 306 via the external I/F 315, the external I/F 181, the internal I/F 182. The sheet bundle detection sensor group 27 includes, for example, the short-side sensor 27a and the long-side sensor 27b as in the above-described embodiments. The image forming device controller 306 to which the detection signal of each sensor is input executes the determination, as in each of the above-described embodiments. Further, the image forming device controller 306 that has executed the determination transmits an output instruction to the notification device 310 (the notification unit having the similar configuration to any one of the display 301, the LED emitter 29 and the sound output mechanism 30 according to the above-described embodiments and modifications), and controls to output a notification of the determination result (detection result).

The present disclosure is not limited to specific embodiments described above, and numerous additional modifications and variations are possible in light of the teachings within the technical scope of the appended claims. It is therefore to be understood that the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

In the above-described embodiments, the CPU 110 that controls the sheet binding unit 100 sends the output instruction to the notification device in the image forming device 300 (i.e., the display 301) or the notification device in the sheet binding unit 100 (i.e., the LED emitter 29 and the sound output mechanism 30) to output a notification of the determination result (detection result). However, the configuration of the present disclosure is not limited to the above-described configuration. For example, the CPU 110 may output a notification to the LED emitter 29 or the sound output mechanism 30 in the image forming device 300 or the display 301 in the sheet binding unit 100. Further, when a notification is output to these notification devices, the determination result (detection result) may be output by the CPU 110 or the image forming device controller 306.

Aspects of the present disclosure are, for example, as follows.

### Aspect 1

In Aspect 1, a medium processing apparatus for forming a sheet bundle by bundling multiple sheet-like media includes a sheet binder, a first sensor, a second sensor, and a notification device. The sheet binder binds the sheet bundle inserted in a space formed in a part of a housing of the medium processing apparatus. The first sensor is disposed in the space and detects the position of one side of the sheet bundle in the space. The second sensor detects the position of another side adjacent to the one side of the sheet bundle. The notification device notifies a user of the detection result of the first sensor and the second sensor.

### Aspect 2

In Aspect 2, the medium processing apparatus according to Aspect 1 further includes a determination unit to select a position information of the sheet bundle inside the space according to detection signals obtained by the first sensor and the second sensor, among at least three types of selections and determine the selected position information. The notification device notifies the user of the detection result as a determination result by the determination unit.

### Aspect 3

In Aspect 3, the medium processing apparatus according to Aspect 2 further includes a controller including the determination unit. The controller inputs the detection signals of the first sensor and the second sensor, and causes the determination unit to perform the determination.

### Aspect 4

In Aspect 4, in the medium processing device according to any one of Aspects 1 to 3, the notification device causes a display unit to display the image selected or generated based on the detection signals of the first sensor and the second sensor as the detection result.

### Aspect 5

In Aspect 5, in the medium processing apparatus according to Aspect 4, the notification device displays an executable position at which the binding unit can execute the sheet binding operation, on the image in a superimposed manner.

### Aspect 6

In Aspect 6, in the medium processing device according to any one of Aspects 1 to 3, the notification device includes a light emitter to vary an emission state according to the detection result.

### Aspect 7

In Aspect 7, in the medium processing device according to any one of Aspect 1 to 3, the notification device includes a sound output unit to output sound according to the detection result.

### Aspect 8

In Aspect 8, in the medium processing apparatus according to any one of Aspects 1 to 7, the sheet binder performs a stapling operation to bind an end portion of the sheet bundle using a binding staple.

### Aspect 9

In Aspect 9, in the medium processing apparatus according to any one of Aspects 1 to 7, the sheet binder performs a crimp binding operation to crimp and bind by pressing and deforming a part of the sheet bundle.

### Aspect 10

In Aspect 10, the medium processing apparatus according to any one of Aspects 1 to 7 further includes multiple sheet binders including a stapler to bind an end portion of the sheet bundle using a binding staple, and a crimp binder to crimp and bind a part of the sheet bundle by pressing and deforming the sheet bundle.

### Aspect 11

In Aspect 11, an image forming apparatus includes an image forming device to form an image on a sheet-like medium, and the medium processing apparatus according to any one of Aspects 1 to 9 to perform a sheet binding operation on the medium on which the image is formed by the image forming device.

### Aspect 12

In Aspect 12, an image forming system includes an image forming apparatus to form an image on a sheet-like medium, a medium processing apparatus coupled to the image forming apparatus to form a sheet bundle by bundling multiple sheet-like media including the medium, and a notification device. The medium processing apparatus includes a sheet binder, a first sensor, and a second sensor. The sheet binder binds the sheet bundle inserted in a space formed in a part of a housing of the medium processing apparatus. The first sensor is disposed in the space and detects the position of one side in one direction that forms an outer edge of the sheet bundle in the space. The second sensor detects the position of another side adjacent to the one side of the sheet bundle. The notification device outputs a notification of the detection result of the first sensor and the second sensor.

### Aspect 13

In Aspect 13, a medium processing apparatus includes a housing, a binder, a first sensor, a second sensor, and circuitry. The housing has a space in a part of the housing. The binder is disposed in the space to perform a binding operation on a sheet bundle bundling multiple media including a medium. The first sensor is disposed in the space to detect a first side of the sheet bundle in a first direction, the first side forming an outer edge of the sheet bundle, and output a first detection signal. The second sensor is disposed adjacent to the first sensor in the space to detect a second side of the sheet bundle adjacent to the first side, the second side forming another outer edge of the sheet bundle in a second direction different from the first direction, and output a second detection signal. The circuitry is to input the first detection signal output by the first sensor and the second detection signal output by the second sensor, output a notification that the binding operation is executable by the binder, and cause the binder to perform the binding operation in response to receiving an instruction to start the binding operation.

### Aspect 14

In Aspect 14, in the medium processing apparatus according to Aspect 13, the circuitry is further to select one of at least three types of position information of the sheet bundle in the space, according to the first detection signal and the second detection signal, and output a notification of the position information of the sheet bundle.

### Aspect 15

In Aspect 15, the medium processing apparatus according to Aspect 14, the circuitry is further to input the first detection signal and the second detection signal, and select the position information of the sheet bundle.

### Aspect 16

In Aspect 16, the medium processing apparatus according to any one of Aspects 13 to 15 further includes a display. The circuitry is further to control the display to display an image selected or generated based on the first detection signal and the second detection signal.

### Aspect 17

In Aspect 17, in the medium processing apparatus according to Aspect 16, the circuitry is to superimpose an executable position at which the binder performs the binding operation, on the image to generate a superimposed image, and control the display to display the superimposed image.

### Aspect 18

In Aspect 18, the medium processing device according to any one of Aspects 13 to 15 further includes a light emitter. The circuitry is further to control the light emitter to vary light emission according to the notification.

### Aspect 19

In Aspect 19, the medium processing device according to any one of Aspects 13 to 15 further includes a speaker. The circuitry is further to control the speaker to output sound according to the notification.

### Aspect 20

In Aspect 20, in the medium processing apparatus according to Aspect 13, wherein the first sensor and the second sensor are closer to an interior of the housing than a binding position of the binder in the space.

### Aspect 21

In Aspect 21, the medium processing device according to any one of Aspect 13 further includes a first restrictor and a second restrictor. The first restrictor restricts the first side in the first direction. The second restrictor restricts the second side in the second direction adjacent to the first side.

### Aspect 22

In Aspect 22, in the medium processing apparatus according to Aspect 21, the first sensor and the second sensor are respectively closer to an exterior of the housing than the first restrictor and the second restrictor.

### Aspect 23

In Aspect 23, the medium processing device according to any one of Aspect 13 further includes multiple first sensors including the first sensor, and multiple second sensors including the second sensor.

### Aspect 24

In Aspect 24, an image forming apparatus includes an image forming device to form an image on a medium, and the medium processing apparatus according to Aspect 13 to perform a binding operation on the medium on which the image is formed by the image forming device.

### Aspect 25

In Aspect 25, an image forming system includes an image forming apparatus, a medium processing apparatus, and circuitry. The image forming apparatus forms an image on a medium. The medium processing apparatus is coupled to the image forming apparatus to form a sheet bundle bundling multiple media including the medium. The medium processing apparatus includes a housing, a binder, a first sensor, and a second sensor. The housing has a space in a part of the housing. The binder is disposed in the space to perform a binding operation on a sheet bundle bundling multiple media including a medium. The first sensor is disposed in the space to detect a first side of the sheet bundle in a first direction, the first side forming an outer edge of the sheet bundle, and output a first detection signal. The second sensor is disposed adjacent to the first sensor in the space to detect a second side of the sheet bundle adjacent to the first side, the second side forming another outer edge of the sheet bundle in a second direction different from the first direction, and output a second detection signal. The circuitry is to input the first detection signal output by the first sensor and the second detection signal output by the second sensor, output a notification that the binding operation is executable by the binder, and cause the binder to perform the binding operation in response to receiving an instruction to start the binding operation.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A medium processing apparatus comprising:
a housing having a space in a part of the housing;
a binder in the space to perform a binding operation on a sheet bundle bundling multiple media including a medium;
a first sensor in the space to:
detect a first side of the sheet bundle in a first direction, the first side forming an outer edge of the sheet bundle; and
output a first detection signal;
a second sensor adjacent to the first sensor in the space to:
detect a second side of the sheet bundle adjacent to the first side, the second side forming another outer edge of the sheet bundle in a second direction different from the first direction; and
output a second detection signal; and
circuitry configured to:
input the first detection signal output by the first sensor and the second detection signal output by the second sensor;
output a notification that the binding operation is executable by the binder; and
cause the binder to perform the binding operation in response to receiving an instruction to start the binding operation.

2. The medium processing apparatus according to claim 1,
wherein the circuitry is further configured to:
select one of at least three types of position information of the sheet bundle in the space, according to the first detection signal and the second detection signal; and
output a notification of the position information of the sheet bundle.

3. The medium processing apparatus according to claim 2,
wherein the circuitry is further configured to:
input the first detection signal and the second detection signal; and
select the position information of the sheet bundle.

4. The medium processing apparatus according to claim 1, further comprising a display,
wherein the circuitry is further configured to control the display to display an image selected or generated based on the first detection signal and the second detection signal.

5. The medium processing apparatus according to claim 4,
wherein the circuitry is configured to:
superimpose an executable position at which the binder performs the binding operation, on the image to generate a superimposed image; and
control the display to display the superimposed image.

6. The medium processing apparatus according to claim 1, further comprising a light emitter,
wherein the circuitry is further configured to control the light emitter to vary light emission according to the notification.

7. The medium processing apparatus according to claim 1, further comprising a speaker,
wherein the circuitry is further configured to control the speaker to output sound according to the notification.

8. The medium processing apparatus according to claim 1,
wherein the first sensor and the second sensor are closer to an interior of the housing than a binding position of the binder in the space.

9. The medium processing apparatus according to claim 1, further comprising:
a first restrictor to restrict the first side in the first direction; and
a second restrictor to restrict the second side in the second direction adjacent to the first side.

10. The medium processing apparatus according to claim 9,
wherein the first sensor and the second sensor are respectively closer to an exterior of the housing than the first restrictor and the second restrictor.

11. The medium processing apparatus according to claim 1, further comprising:
multiple first sensors including the first sensor; and
multiple second sensors including the second sensor.

12. An image forming apparatus comprising:
an image forming device to form an image on a medium; and
the medium processing apparatus according to claim 1, to perform a binding operation on the medium on which the image is formed by the image forming device.

13. An image forming system comprising:
an image forming apparatus to form an image on a medium;
a medium processing apparatus coupled to the image forming apparatus to form a sheet bundle bundling multiple media including the medium,
the medium processing apparatus including
a housing having a space in a part of the housing;
a binder in the space to perform a binding operation on a sheet bundle bundling multiple media including a medium;
a first sensor in the space to:
detect a first side of the sheet bundle in a first direction, the first side forming an outer edge of the sheet bundle; and
output a first detection signal; and
a second sensor adjacent to the first sensor in the space to:
detect a second side of the sheet bundle adjacent to the first side, the second side forming another outer edge of the sheet bundle in a second direction different from the first direction; and
output a second detection signal; and
circuitry configured to:
input the first detection signal output by the first sensor and the second detection signal output by the second sensor;
output a notification that the binding operation is executable by the binder; and
cause the binder to perform the binding operation in response to receiving an instruction to start the binding operation.
